(19) United States
(12) Patent Application Publication
(10) Pub. No.: US 2013/0030964 A1
(43) Pub. Date: Jan. 31, 2013

(54) LOCATION-BASED PAYER CHARGING SYSTEM

(71) Applicants: Frank Anthony Nuzzi, Pflugerville, TX (US); Farah Naz Amin, Austin, TX (US); Subramanian Srinivasan, Milpitas, CA (US)

(72) Inventors: Frank Anthony Nuzzi, Pflugerville, TX (US); Farah Naz Amin, Austin, TX (US); Subramanian Srinivasan, Milpitas, CA (US)

(73) Assignee: eBAY, INC., San Jose, CA (US)

(21) Appl. No.: 13/492,402

(22) Filed: Jun. 8, 2012

Related U.S. Application Data
(63) Continuation-in-part of application No. 13/191,166, filed on Jul. 26, 2011.

(51) Int. Cl. G06Q 30/04

(52) U.S. Cl. 705/30

(57) ABSTRACT

A location-based payer charging system includes a charging database including at least one transportation charge element associated with a transportation provider. A system provider device in the location-based payer charging system is coupled to a network and the charging database. The system provider device is operable to receive first location data from a payer device over the network in response to the payer device entering a first transportation area, and then receive second location data from the payer device over the network in response to the payer device exiting a second transportation area. The system provider device will then determine a payment amount using the first location data, the second location data, and a transportation charge element retrieved from the charging data, and send an instruction to charge the payment amount to a payer account that is associated with the payer device.

### CROSS REFERENCE TO RELATED APPLICATIONS

This application is a continuation-in-part application of U.S. patent application Ser. No. 13/191,166, Attorney Docket No. 70481.351 (P1282US1), filed Jul. 26, 2011, which is incorporated by reference in its entirely.

### BACKGROUND

1. Field of the Invention

The present invention generally relates to online and/or mobile payments and more particularly to a location-based payer charging system.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an online or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why online and mobile purchases are growing very quickly.

One limitation to online or mobile purchasing involves a payer attending an event such as, for example, an amusement park, a fair, carnival, a music festival, a sightseeing area, and/or a variety of other events known in the art. Conventionally, the use of online or mobile payments with regard to events is limited to buying a ticket for the event online or with a mobile device prior to the event and then providing that ticket at the event in order to enter the event. Such conventional uses fail to take advantage of the benefits provided by mobile devices that could allow a wide variety of different event charging schemes. Furthermore, event providers may wish to charge the payer based on the areas of the event visited and/or activities participated in during the event. Such charges typically must be paid for using cash, as the conventional methods of using of a mobile device to repeatedly make payments within the event is undesirable for both the event provider and the payer.

Similar limitations exist with regard to charging a payer for transportation.

Transportation systems such as, for example, trains and bus systems, are almost entirely based on paper tickets or fund storage cards that are purchased and presented at the transportation system in order to allow a user to use the transportation system. Other transportation systems such as, for example, toll roads or bridges, require payment at toll stops or the use of a transponder system for automatic payment. The provision of paper tickets, fund storage cards, transponder devices, and the associated systems to enable payment to transportation providers makes these systems costly to produce and operate.

Thus, there is a need for an improved payer charging system.

### SUMMARY

According to one embodiment, a method for charging a payer includes receiving first location data from a payer device upon the payer device entering a first transportation area in a transportation system. Second location data is then received from the payer device upon the payer device exiting a second transportation area of the transportation system. A payment amount is then calculated using the first location data, the second location data, and a transportation charge element retrieved from a database, and an instruction is sent to make a payment for the payment amount. Transportation access information may be provided to the payer and/or the transportation provider to facilitate the entry and/or exit of the payer to and from the transportation system.

As a result, a payer may inform the payer charging system upon entering a transportation system associated with a transportation provider, and the payer charging system may charge the payer upon the payer leaving the transportation system by determining the cost associating with the payer traveling between two locations. The sending of information between the payer device and the payer charging system, and the operations of the payer charging system, may be automated (e.g., upon the payer device entering and/or existing the transportation system) in order to charge the payer for using the transportation system with little or no action required by the payer.

These and other features and advantages of the present disclosure will be more readily apparent from the detailed description of the embodiments set forth below taken in conjunction with the accompanying figures.

### BRIEF DESCRIPTION OF THE FIGURES

FIG. 1 is a flow chart illustrating an embodiment of a method for charging a payer;

FIG. 2a is a schematic view illustrating an embodiment of an event area;

FIG. 2b is a map view illustrating an embodiment of the event area of FIG. 2a;

FIG. 3a is a front view illustrating an embodiment of a payer device displaying a notification in response to being detected entering or attempting to enter an event area;

FIG. 3b is a front view illustrating an embodiment of a payer device displaying a ticket purchasing screen in response to choosing to enter an event area;

FIG. 3c is a front view illustrating an embodiment of a payer device displaying an electronic ticket;

FIG. 4 is a front view illustrating an embodiment of a payer device displaying an notification in response to being detected leaving or attempting to leave the event area;

FIG. 5a is a schematic view illustrating an embodiment of event area including a plurality of pay areas within the event area;

FIG. 5b is a map view illustrating an embodiment of the event area of FIG. 5a;

FIG. 5c is a front view illustrating an embodiment of a payer device displaying a notification in response to being detected entering or attempting to enter a pay area;

FIG. 5d is a front view illustrating an embodiment of a payer device displaying a ticket purchasing screen in response to choosing to enter a pay area;

FIG. 5e is a front view illustrating an embodiment of a payer device displaying an electronic ticket;

FIG. 6a is a front view illustrating an embodiment of a payer device displaying an associated device screen in response to entering or attempting to enter an event area;

FIG. 6b is a schematic view illustrating an embodiment of a primary payer device linked with a secondary payer device and a plurality of associated payer devices;

FIG. 7 is a front view illustrating an embodiment of a payer device displaying a warning screen in response to detecting a predetermined event invoice amount;

FIG. 8 is a flow chart illustrating an embodiment of a method for charging a payer;

FIG. 9 is a map view illustrating an embodiment of a transportation system;

FIG. 10a is a front view illustrating an embodiment of a payer device displaying a transportation provider selection screen;

FIG. 10b is a front view illustrating an embodiment of a payer device displaying a transportation provider confirmation screen;

FIG. 10c is a perspective view illustrating an embodiment of an transportation area access device;

FIG. 10d is a front view illustrating an embodiment of a payer device displaying an electronic ticket.

FIG. 10e is a front view illustrating an embodiment of a payer device displaying an payment confirmation screen;

FIG. 10f is a front view illustrating an embodiment of a payer device displaying an ticket split screen;

FIG. 11 is a schematic view illustrating an embodiment of a networked system;

FIG. 12 is a perspective view illustrating an embodiment of a payer device;

FIG. 13 is a schematic view illustrating an embodiment of a computer system; and

FIG. 14 is a schematic view illustrating an embodiment of a payer charging system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides a system and method for charging a payer based on the location of the payer at an event such as, for example, a fair, a carnival, an amusement park, a music festival, a sight seeing area (e.g., a national park), a sporting event, and/or a variety of other events known in the art. The payer includes a payer device that is associated with a payer account. The payer account may be provided by a payee/event provider that is providing the event, an account provider (e.g., a credit account provider, a checking account provider, a savings account provider, and/or a variety of other account providers known in the art), and/or a payment service provider that provides payment services for the event (e.g., PayPal Inc. of San Jose, Calif.) by, for example, providing a payer account for the payer, a payee account for the payee, and/or transferring payments from a payer account (e.g., provided by the account provider) to a payee account (e.g., provided by the account provider). A payer device detection system is operable to detect payer devices entering or attempting to enter and leaving or attempting to leave the area of the event. Upon detecting a payer device entering the event, the payer device is associated with an event invoice, and when the payer device is involved in a payer charging event while being located in the event area, a charge is associated with the event invoice. Upon detecting the payer device leaving or attempting to leave the event area, the payer account is charged for the event invoice.

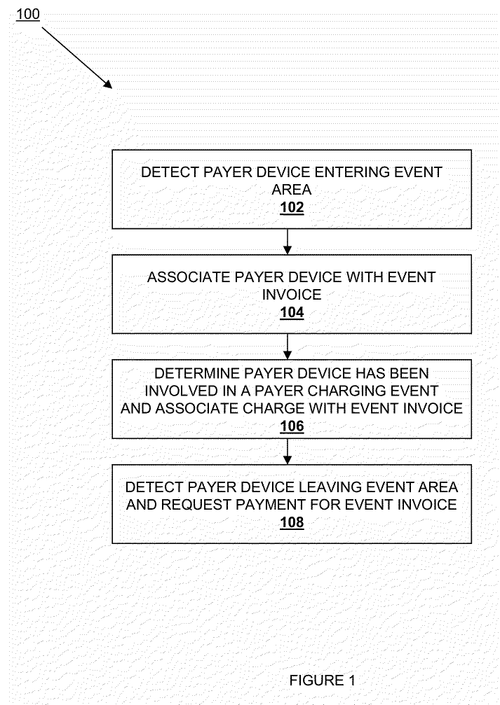

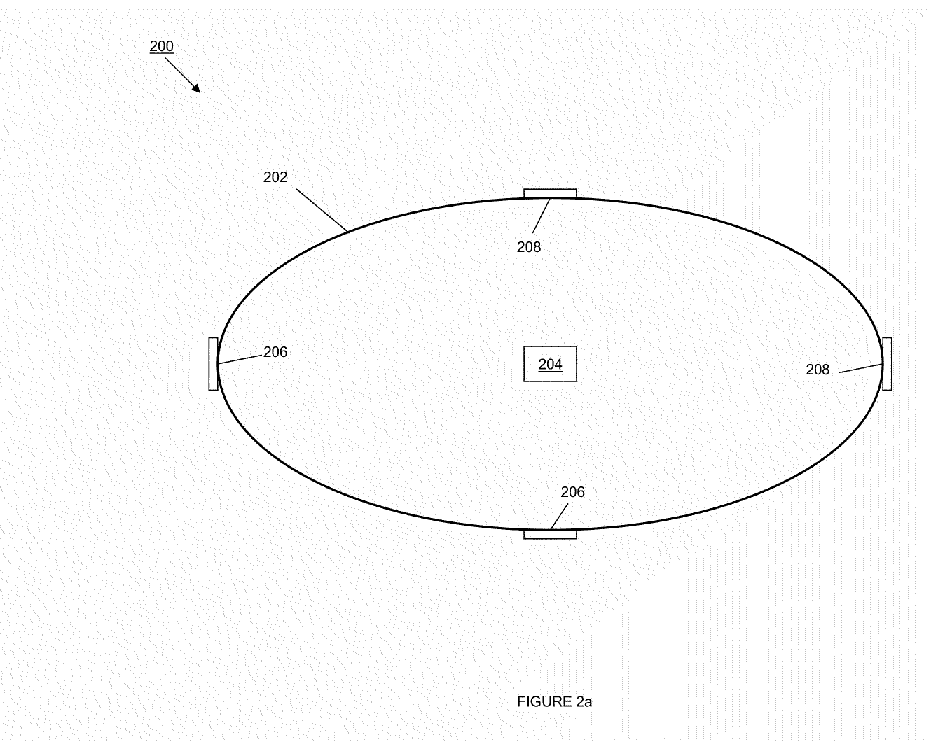

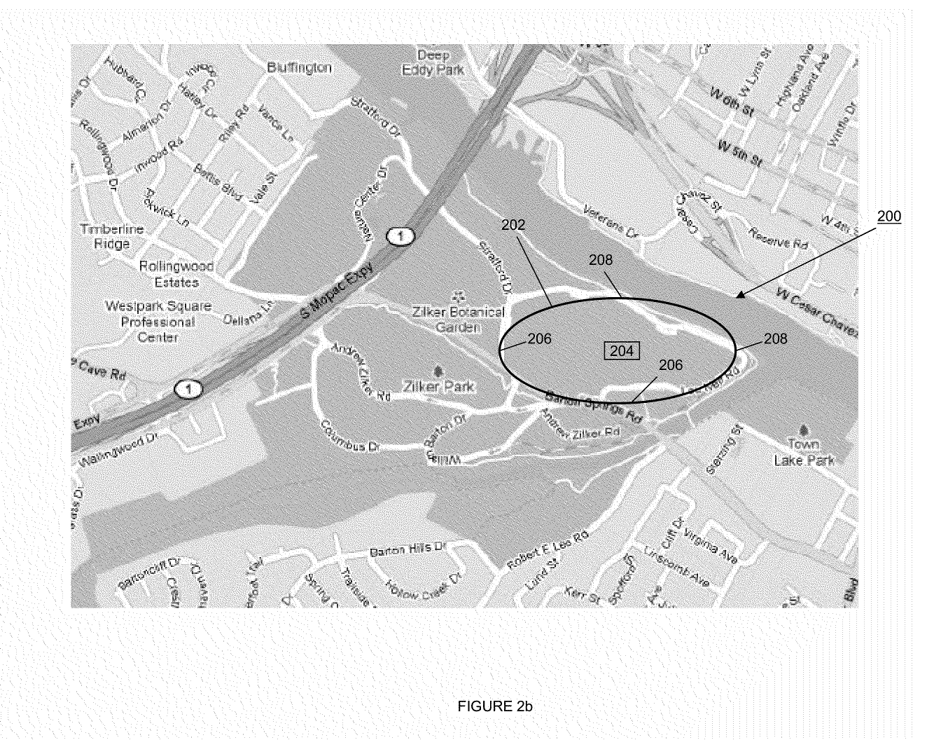

Referring now to FIGS. 1, 2a, and 2b, a method 100 for charging a payer is illustrated. The method 100 begins at block 102 where a payer device is detected entering or attempting to enter an event area. FIGS. 2a illustrates an embodiment of a location based payer charging system 200 that may include an event area that is bounded by a perimeter 202, a networking system 204, and/or a plurality of event area entrances 206 and exits 208. In an embodiment, the payee/event provider may define the event area using a plurality of positioning coordinates. For example, FIG. 2b illustrates how the event area may be defined by the perimeter 202 that includes a plurality of Global Positioning System (GPS) coordinates on a map. One of skill in the art will recognize that a variety of different sized and shaped boundaries (e.g., the oval shaped boundary provided by the perimeter 202 of the event area in the illustrated embodiment) may be created to define one or more event areas while remaining within the scope of the present disclosure. In an embodiment, the location based payer charging system 200 may be operated by the payee/event provider, the payment service provider, a location based payer charging system provider, and/or a variety of other entities known in the art. Thus, in an embodiment, the payee/event provider may provide the positioning coordinates for the event area to the entity operating the location based payer charging system 200.

The event area may be provided for an event that requires a payer to pay in order to enter any portion of the event area. In one embodiment, the perimeter 202 of the event area may coincide or be positioned adjacent to fencing or other obstructions that are used to prevent entrance to the event area, while the event area entrances 206 may provide the only entrances to the event area and the event area exits 208 may provide the only exits from the event area 200. Thus, GPS coordinates may be provided to coincide with the event area entrances 206 and the event area exits 208 such that they are operable to be used to detect payer devices entering the event area through the event area entrances 206 and leaving the event area through the event area exits 208. Alternatively or in combination, GPS coordinates may also be provided to coincide with the event area such that they are operable to be used to detect payer devices located anywhere near or within the perimeter 202 of the event area.

In another embodiment, event area entrances and exits may coincide with each other. In such a case, the system may be determine an entry when a payer device first detected near an entrance/exit and an exit may be determined when the payer device is next detected near an entrance/exit. Alternatively, entry may be determined when the payer device is detected within the perimeter 202 and exit may be determined when the payer device is detected outside the perimeter 202.

In another embodiment, the event area may be provided for an event that does not require a payer to pay in order to enter the event area, or instead asks for voluntary donations to enter the event area. As such, the perimeter 202 of the event area may be unobstructed, and GPS coordinates may be provided to define the perimeter 202 such that they are operable to be used to detect payer devices entering and exiting the event area across any portion of the perimeter 202. Alternatively, GPS coordinates may also be provided to coincide with the event area such that they are operable to be used to detect payer devices located anywhere near or within the perimeter 202 of the event area.

In an embodiment, the networking system 204 may include one or more devices to provide a network that covers the event area and, in one embodiment, a limited area that extends outside the perimeter 202 of the event area. For example, the networking system 204 may provide a network such as, for example, a Local Area Network (LAN), that extends throughout the event area and approximately 5-10 feet beyond the perimeter 202 of the event area.

At block 102, a payer including a payer device approaches the perimeter 202 of the event area 200 and is detected by the location based payer charging system 200 as entering or attempting to enter the event area. In an embodiment, the payer device may include an application that allows the payer device to be used in the location based payer charging system 200. For example, the user of the payer device may have added the application to the payer device to attend the event and be charged using the location based payer charging system 200. In such an embodiment, the application may be updated with the GPS coordinates provided by the payee/event provider to define the event area, and the application monitors the location of the payer device (e.g., using a GPS device in the payer device) to determine whether the payer device is within a predetermined distance of the event area. Once within the predetermined distance of the event area, the application communicates with the location based payer charging system 200 (e.g., over a network such as the Internet) such that the payer device is detected as entering or attempting to enter the event area by the location based charging system 200.

In another embodiment, the payer device may detect the LAN provided by the networking system 204 and be prompted to connect to the LAN such that the payer device is detected by the location based payer charging system 200 as entering or attempting to enter the event area. Connection of the payer device to the LAN may cause the location based payer charging system 200 to cause the payer device to connect to the location based payer charging system 200 through another communications link such as, for example, a cellular communications link that provides an Internet connection. While a few examples of systems and methods to detect the payer device have been provided, one of skill in the art will recognize that these should not be viewed as limiting, and a variety of other systems and methods to detect that the payer device is entering or attempting to enter the event area will fall within the scope of the present disclosure.

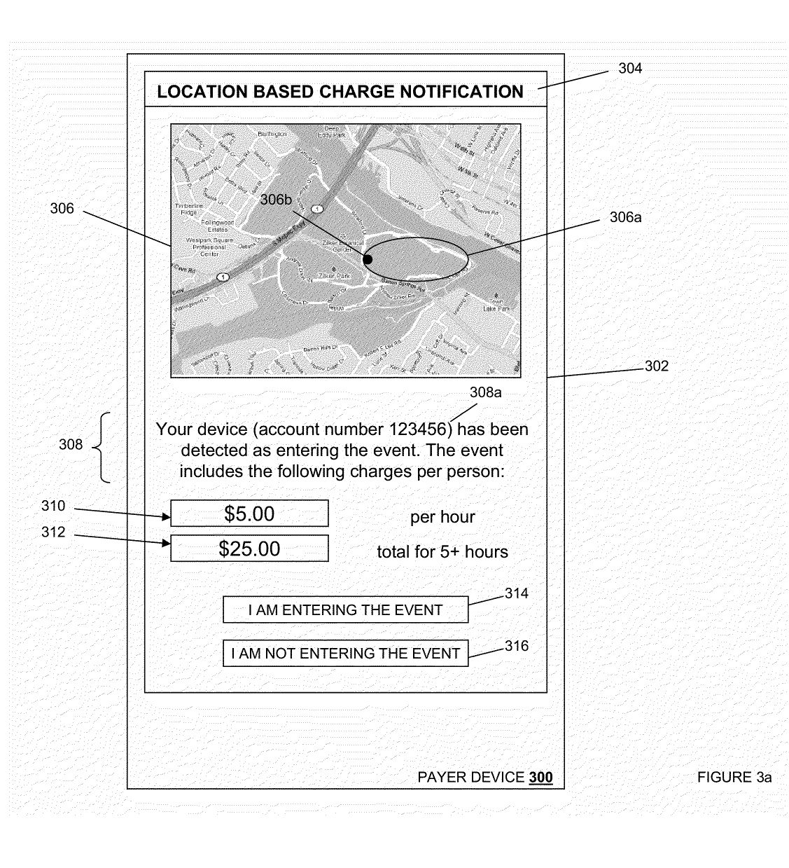

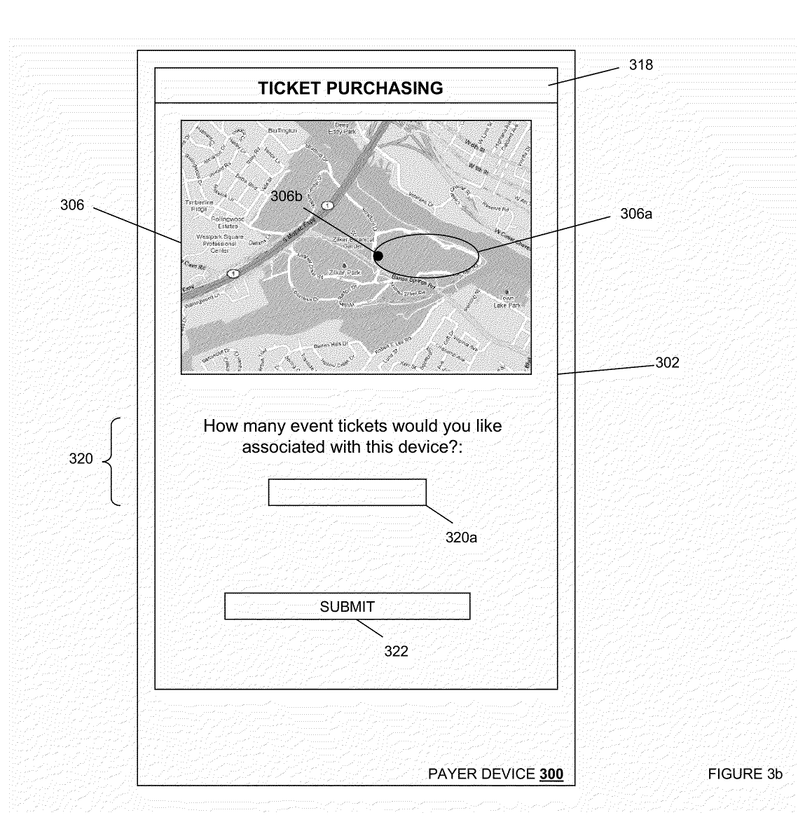

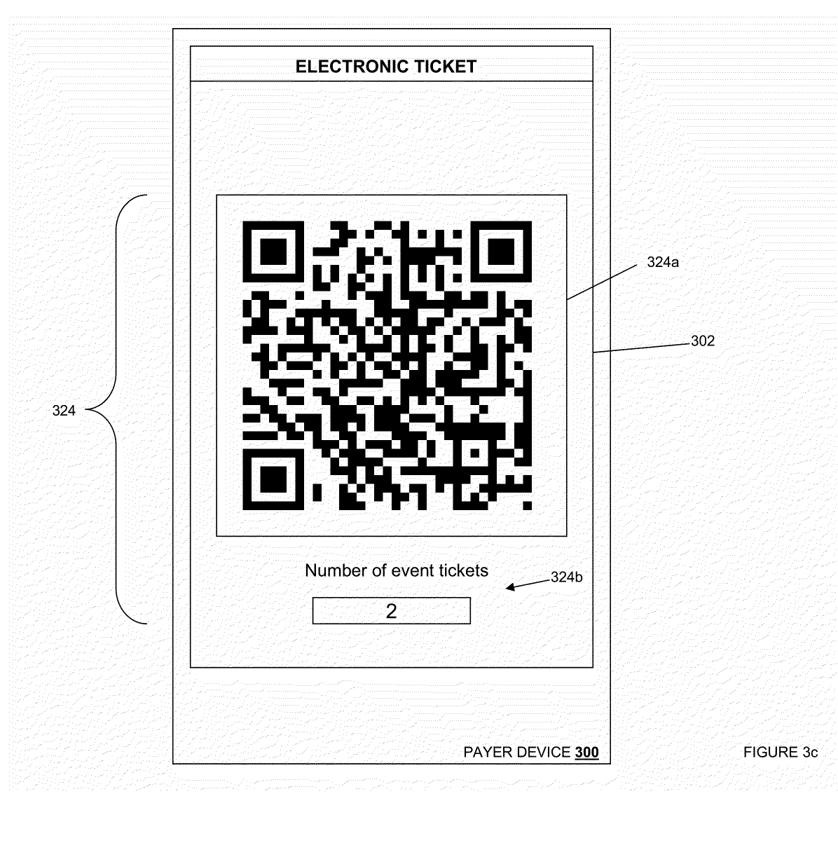

Referring now to FIGS. 1, 3a, 3b, 3c, and FIG. 4, the method 100 proceeds to block 104 where the payer device is associated with an event invoice. In response to detecting the payer device entering or attempting to enter the event area at block 102 of the method 100, the location based payer charging system 200 communicatively connects to the payer device through a network such as, for example, the Internet, the LAN provided by the networking system 204, and/or a variety of other networks known in the art. FIGS. 3a, 3b, and 3c illustrate an embodiment of a payer device 300 that is communicatively connected to the location based payer system 200. The payer device 300 includes a display 302. In response to detecting the payer device 300 in block 102 of the method 100, the location based payer charging system 200 sends a location based charge notification 304 to the payer device 300. In the illustrated embodiment, the location based charge notification 304 includes a map 306 having a graphical representation of the perimeter 306a of the event area and a payer indicator 306b that indicates where on the map 306 the payer device 300 has been detected.

The charge notification 304 also includes an information section 308 that informs the user of the payer device 300 that the payer device 300 has been detected. In the illustrated embodiment, the information section 308 includes an account number 308a that is associated with a payer account. In an embodiment, the user of the payer device 300 may have already signed into the payer account the payee, with a payment service provider, or an account provider, and the account number 308a may be retrieved using a cookie stored in the payer device 300 that associates the payer account with the payer device 300. In another embodiment, the user of the payer device 300 may have been required to sign into the payer account (e.g., when starting the application used to allow the payer device to be detected by the location based payer charging system 200, when connecting to the LAN provided by the networking system 204, etc.) such that the account number 308a is available for display on the location based charge notification 304. In another embodiment, the account number 308a may be partially obscured or even omitted from the charge notification 304.

The charge notification 304 also includes a plurality of pricing indicators 310 and 312. The pricing indicator 310 indicates that the cost of the event is $5.00/hour, while the pricing indicator 312 indicates that the cost of the event is $25.00 total for more than 5 hours.

The illustrated pricing indicators 310 and 312 are directed to a time based pricing scheme. However, one of skill in the art will recognize that such time based pricing may be appropriate for some events and not for others. As such, a variety of pricing schemes are envisioned as falling within the scope of the present disclosure, such as, for example, a one time entry fee, a pay-as-you-go scheme, and/or a variety of other pricing schemes known in the art. The charge notification 304 also includes an entering confirmation button 314 and an entering denial button 316. The user of the payer device 300 may select the entering denial button 316 on the charge notification 304 to disconnect from the location based payer charging system 200.

In response to the user of the payer device 300 selecting the entering confirmation button 314 on the charge notification 304, the location based payer charging system 200 associates the payer device 300 (and the payer account that is associated with the payer device 300) with an event invoice in a database. The location based payer charging system 200 may also send a ticket purchasing screen 306, illustrated in FIG. 3b, to the payer device 300 that includes a ticket quantity section 320 having a ticket quantity input box 320a and a submit button 322. The user of the payer device 300 may provide a number of tickets they would like to purchase in the ticket quantity box 320a and select the submit button 322 in order to purchase a desired number of tickets. In response to selecting the submit button 322, the location based payer charging system 200 associates the number of tickets purchased (along with the ticket price) with the event invoice in the database and sends an electronic ticket 324, illustrated in FIG. 3c, that includes a barcode or two-dimensional code, such as a

Quick Response (QR) code 324a, and a ticket quantity indicator 324b. While a specific electronic ticket 324 has been described, one of skill in the art will recognize that the electronic ticket provided by the location based payer charge system 200 in the illustrated embodiment is provided merely as a example, and electronic tickets that do not include QR codes and/or ticket quantity indicators will fall within the scope of the present disclosure.

In an embodiment, the electronic ticket 324 may be used by the user of the payer device 300 to enter the event area. For example, the user of the payer device 300 may provide the electronic ticket 324 for entry through one of the event area entrances 206 (e.g., by providing the QR code 324a to a QR code reader operated by the event provider staff). The electronic ticket 324 may also be periodically requested in the event area to confirm that the user of the payer device 300 is being charged for attending the event. In another embodiment, the electronic ticket 324 may not be used to gain entry to the event area, but rather may simply provide the payer device 300 with a receipt that confirms the purchase of a ticket to the event.

The method 100 then proceeds to block 106 where it is determined that the payer device 300 has been involved in a payer charging event, and a charge is associated with the event invoice that is associated with that payer device 300. For example, in the illustrated embodiment, discussed above, once the payer device 300 enters the event area, the location based charging system 200 may begin tracking the amount of time the payer device 300 has been located in the event area. As discussed above with regard to the illustrated embodiment, any time spent in the event area may be considered a payer charging event, as the event charges the payer based on the amount of time spent in the event area, and thus the event invoice associated with the payer device 300 will be associated with a charge for any amount of time spent in the event area.

The method 100 then proceeds to block 108 where the payer device is detected leaving or attempting to leave the event area and the payment account associated with the payer device is charged for the event invoice. As the payer device 300 approaches the perimeter 202 of the event area 200, the payer device 300 is detected by the location based payer charging system 200 as leaving or attempting to leave the event area. In an embodiment, as discussed above, the payer device 300 may include an application that allows the payer device 300 to be used in the location based payer charging system 200. In such an embodiment, the application has access to the GPS coordinates provided by the payee/event provider to define the event area, and the application monitors the location of the payer device 300 (e.g., using a GPS device in the payer device 300) to determine whether the payer device 300 is within a predetermined distance of the perimeter of the event area. Once within the predetermined distance of the event area, the application communicates with the location based payer charging system 200 such that the payer device 300 is detected as leaving or attempting to leave the event area by the location based charging system 200. In another embodiment, the payer device 300 may be connected to the location based payer charging system 200 through the LAN and/or a cellular communications link that allows the location based payer charging system 200 to monitor the location of the payer device 300 to determine that payer device 300 is leaving or attempting to leave the event area. While a few examples of systems and methods to detect the payer device have been provided, one of skill in the art will recognize that these should not be viewed as limiting, and a variety of other systems and methods to detect that the payer device is leaving or attempting to leave the event area will fall within the scope of the present disclosure.

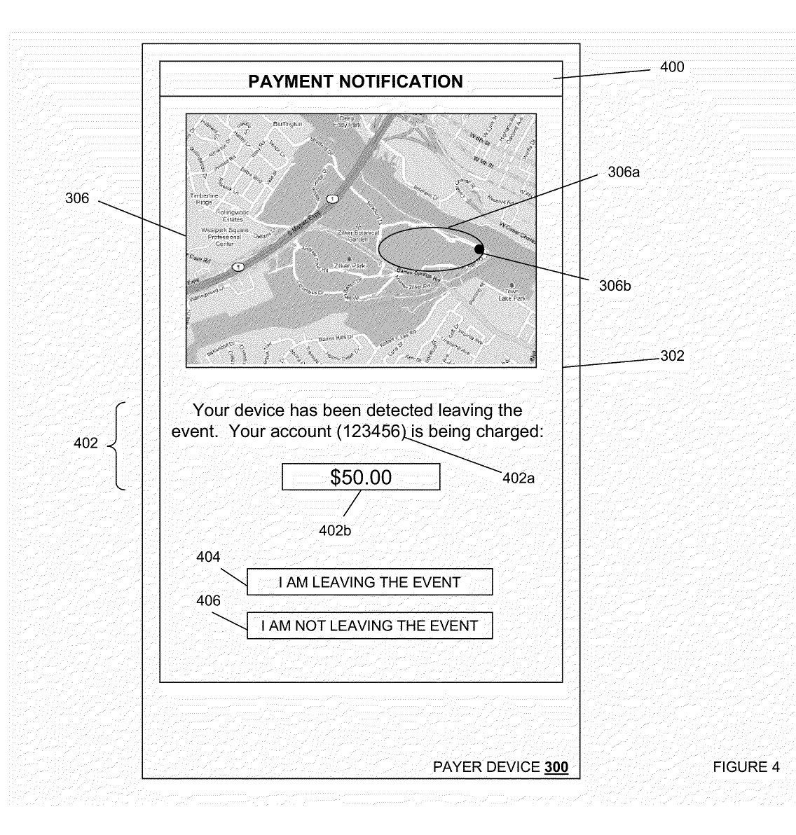

In response to detecting the payer device 300 leaving or attempting to leave the event area at block 108 of the method 100, the location based payer charging system 200 sends a payment notification 400, as illustrated in FIG. 4, to the payer device 300. In the illustrated embodiment, the payment notification 400 includes the map 306 that includes the graphical representation of the perimeter 306a of the event area and the payer indicator 306b that indicates where on the map 306 the payer device 300 has been detected. The payment notification 400 also includes an event invoice area 402 that may include an account number 402a of the payer account that the event invoice will be charged to, a total amount 402b of the event invoice that will be charged to the payer account, a leaving event confirmation button 404, and a leaving event decline button 406. The user of the payer device 300 may select the leaving event decline button 406 if, for example, the payer device 300 was mistakenly brought too close to the perimeter 202 of the event area. The user of the payer device 300 may select the leaving event confirmation button 404 to confirm that the user of the payer device 300 is leaving the event area and that the payment for the total amount 402b of the event invoice should be charged to the payer account associated with the payer device 300. The location based charging system 200 will charge the payer account for the event invoice. In an embodiment, charging the payer account for the event invoice may include the payee/event provider or other operator of the location based payer charging system 200 sending a request to the account provider or the payment service provider to charge the account. Alternatively, the user of the payer device 300 may simply leave the event area and, in response, the location based payer charging system 200 will detect that the payer device 300 is no longer in the event area and charge the payer account for the event invoice.

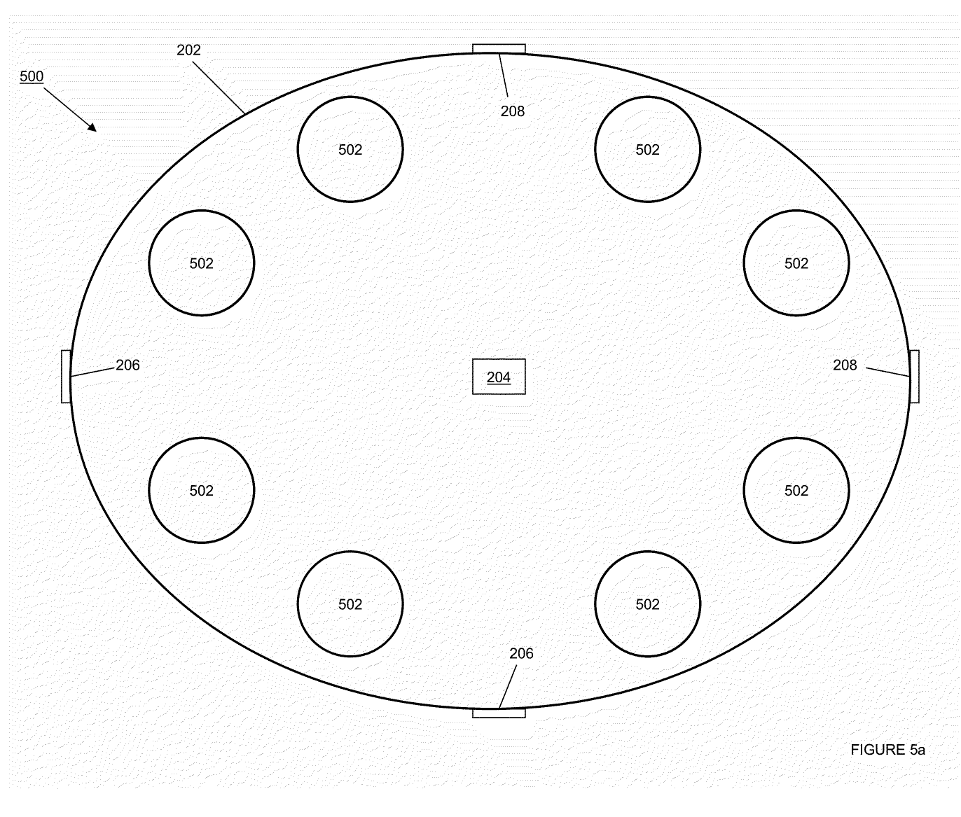

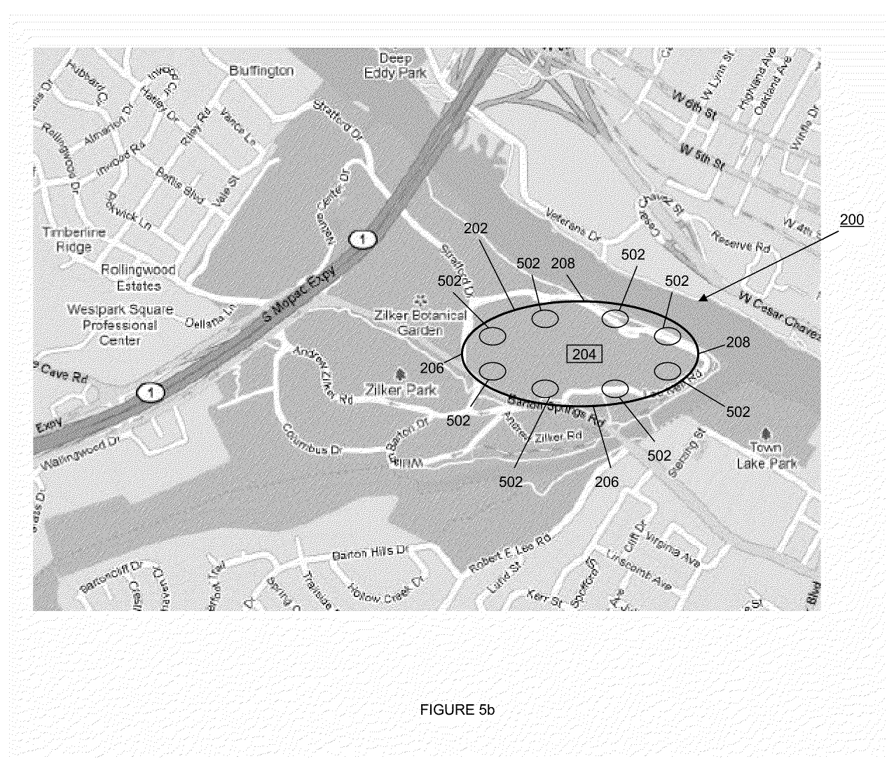

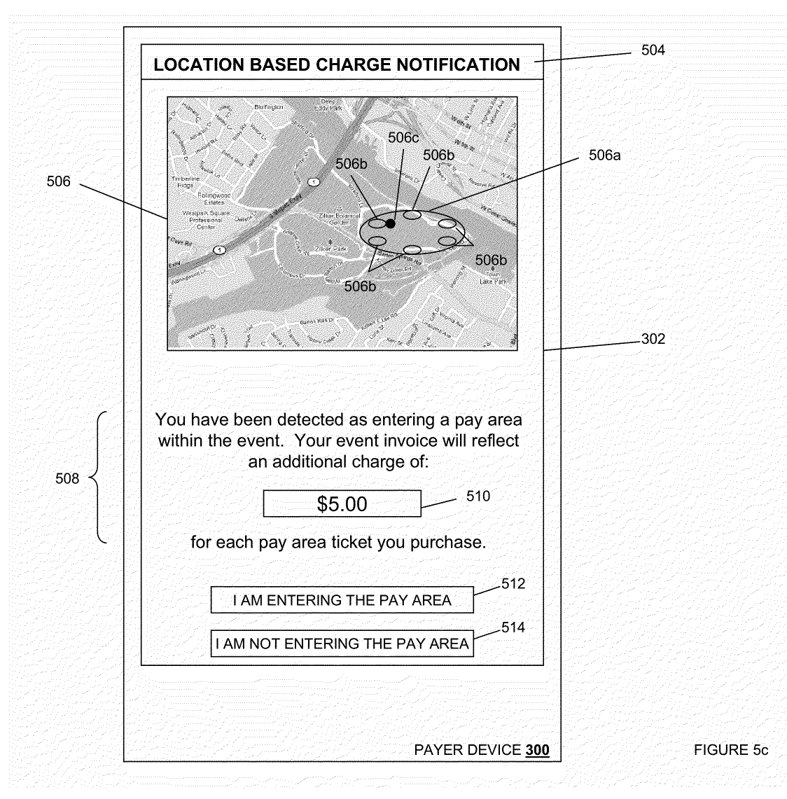

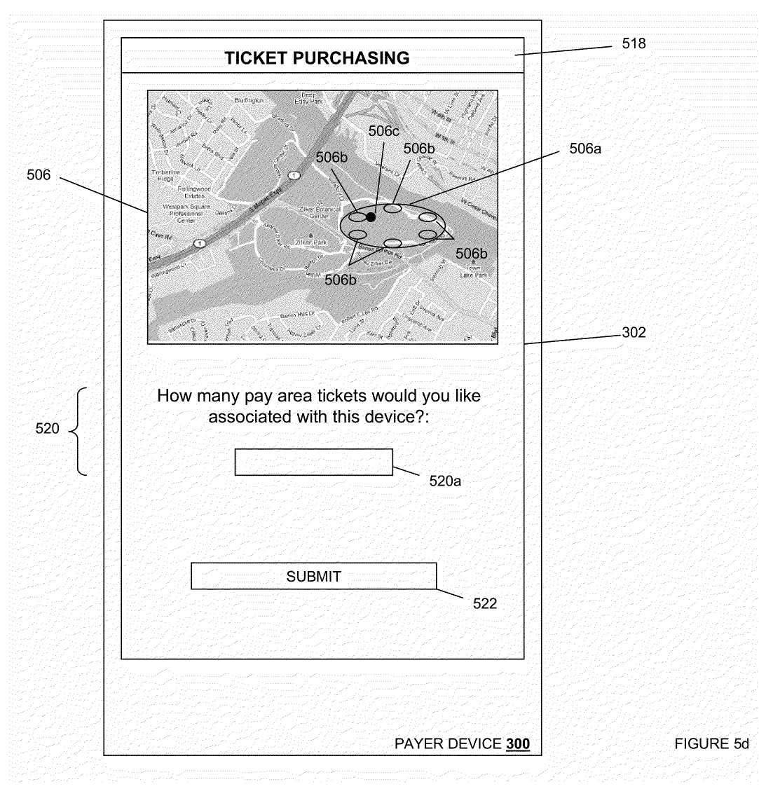

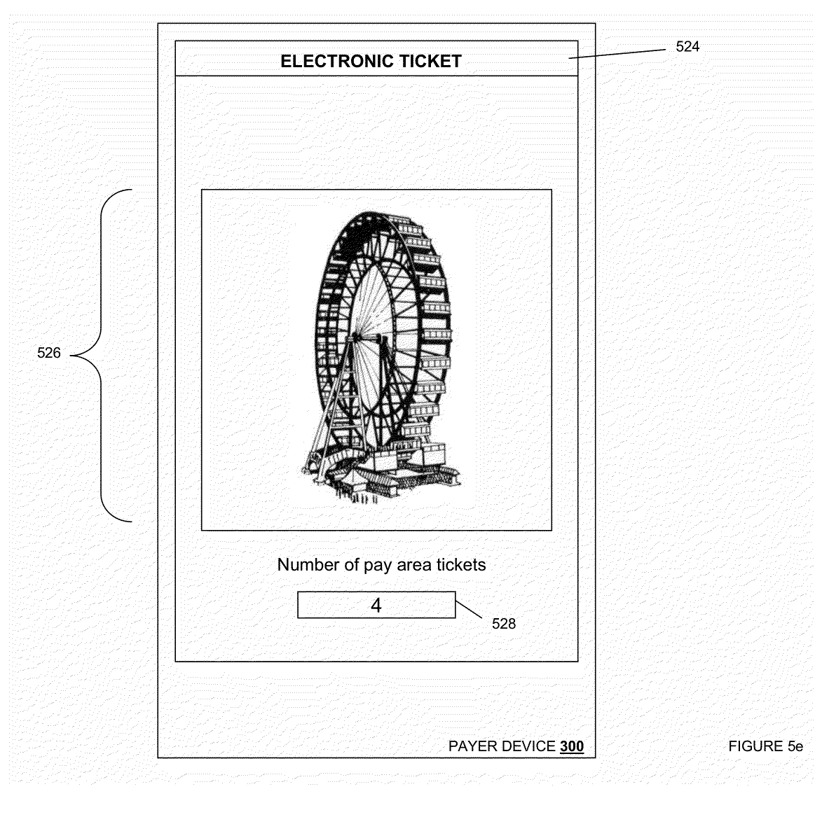

Referring now to FIGS. 5a, 5b, 5c, and 5d, an alternative embodiment of a payer charging event that the payer device 300 may be involved in at block 106 of the method 100 is illustrated. The payer charging event may occur in a location based payer charging system 500 that is substantially similar to the location based payer charging system 200 discussed above, but with the provision of a plurality of pay areas 502 within the event area, as illustrated in FIG. 5a. In an embodiment, the payee/event provider may define the pay areas 502 using a plurality of positioning coordinates in a manner similar to that used to define the event area (e.g., defining a perimeter, defining the area itself, defining entrances and exits to the pay areas, etc.). For example, FIG. 5b illustrates how the pay areas 502 may be defined using a plurality of Global Positioning System (GPS) coordinates on a map. One of skill in the art will recognize that a variety of different sized and shaped boundaries (e.g., the circular shaped boundary provided by the perimeter of the pay areas 502 in the illustrated embodiment) may be created to define one or more pay areas 502 while remaining within the scope of the present disclosure.

At block 106 of the method 100, the payer including the payer device 300 approaches the perimeter of one of the pay areas 502 and is detected by the location based payer charging system 500 as entering or attempting to enter that pay area 502. As discussed above, the payer device 300 may include an application that allows the payer device 300 to be used in the location based payer charging system 200. In such an embodiment, the application is updated with the GPS coordinates provided by the payee/event provider to define the pay areas 502, and the application monitors the location of the payer device 300 (e.g., using a GPS device in the payer device 300) to determine whether the payer device 300 is within a predetermined distance of one of the pay areas 502. Once within the predetermined distance of one of the pay areas 502, the application communicates with the location based payer charging system 500 such that the payer device 300 is detected as entering or attempting to enter that pay area 502 by the location based charging system 500. In another embodiment, the payer device 300 may have detected the LAN provided by the networking system 204 when entering the event area such that the payer device 300 is connected to the LAN or another communications link such as, for example, a cellular communications link that is used to communicate with the payer device to determine the location of the payer device 300. While a few examples of systems and methods to detect the payer device 300 have been provided, one of skill in the art will recognize that these should not be viewed as limiting, and a variety of other systems and methods to detect that the payer device is entering or attempting to enter a pay area 502 will fall within the scope of the present disclosure.

In response to detecting the payer device 300 entering or attempting to enter the pay area 502 in block 106 of the method 100, the location based payer charging system 500 sends a location based charge notification 504 to the payer device 300, as illustrated in FIG. 5c. In the illustrated embodiment, the location based charge notification 504 includes a map 506 that includes a graphical representation of the event area 506a, each of the pay areas 506b within the event area, and a payer indicator 506c that indicates where on the map 506 the payer device 300 has been detected.

The charge notification 504 also includes an information section 508 that informs the user of the payer device 300 that the payer device 300 has been detected as entering or attempting to enter the pay area 502. In the illustrated embodiment, the information section 508 includes a pricing indicator 510 that includes an amount that will be added to the event invoice associated with the payer device 300 and payer account if the user of the payer device chooses to enter the pay area 502. The pricing indicator 310 indicates that the cost of the pay area is $5.00. The illustrated pricing indicator 510 is directed to a flat fee pricing scheme for a particular location in the event area. However, one of skill in the art will recognize that flat fee pricing may be appropriate for some pay areas or event areas and not for others. As such, a variety of pricing schemes are envisioned as falling within the scope of the present disclosure. The charge notification 304 also includes an entering confirmation button 512 and an entering denial button 514. The user of the payer device 300 may select the entering denial button 514 on the charge notification 504 to inform the location based payer charging system 500 that the payer does not wish to enter or be charged for the pay area 502.

In response to the user of the payer device 300 selecting the entering confirmation button 512 on the charge notification 504, the location based payer charging system 500 may send a ticket purchasing screen 518, illustrated in FIG. 5d, to the payer device 300 that includes a ticket quantity section 520 having a ticket quantity input box 520a and a submit button 522. The user of the payer device 300 may provide a number of tickets they would like to purchase to enter the pay area 502 in the ticket quantity box 520a and select the submit button 522 in order to purchase those tickets. In response to selecting the submit button 522, the location based payer charging system 500 adds a charge for the number of tickets purchased to the event invoice that is associated with the payer device 300 and payer account, and sends an electronic ticket 524, illustrated in FIG. 5e, to the payer device 300 that includes an image 526 and a ticket quantity indicator 528 (e.g., the charge added to the event invoice in the illustrated embodiment would be $20.00 for 4 tickets purchased at $5.00 per ticket). While a specific electronic ticket 524 has been described, one of skill in the art will recognize that the electronic ticket provided by the location based payer charge system 500 is provided merely as a example, and electronic tickets that do not include images and/or ticket quantity indicators will fall within the scope of the present disclosure.

In an embodiment, the electronic ticket 524 may be used by the user of the payer device 500 to enter the pay area 502. For example, the location based payer charging system 500 may send the image 526 to a display device in the pay area 502 that the user of the payer device is attempting to enter, and the user of the payer device 300 may provide the electronic ticket 524 displayed on the payer device 300 to enter the pay area 502. A pay area operator in the pay area 502 may then check the image 526 on the payer device 300 to determine whether it matches the image on the display device in the pay area 502. The image 526 provided to each of the payer device 300 and to the display device in the pay area 502 may be periodically changed by the location based payer charging system 500 for security purposes. In another embodiment, the electronic ticket 524 may not be used to gain entry to the pay area 502, but rather may simply provide the payer device 300 with a receipt that confirms the purchase of a ticket to the pay area 502.

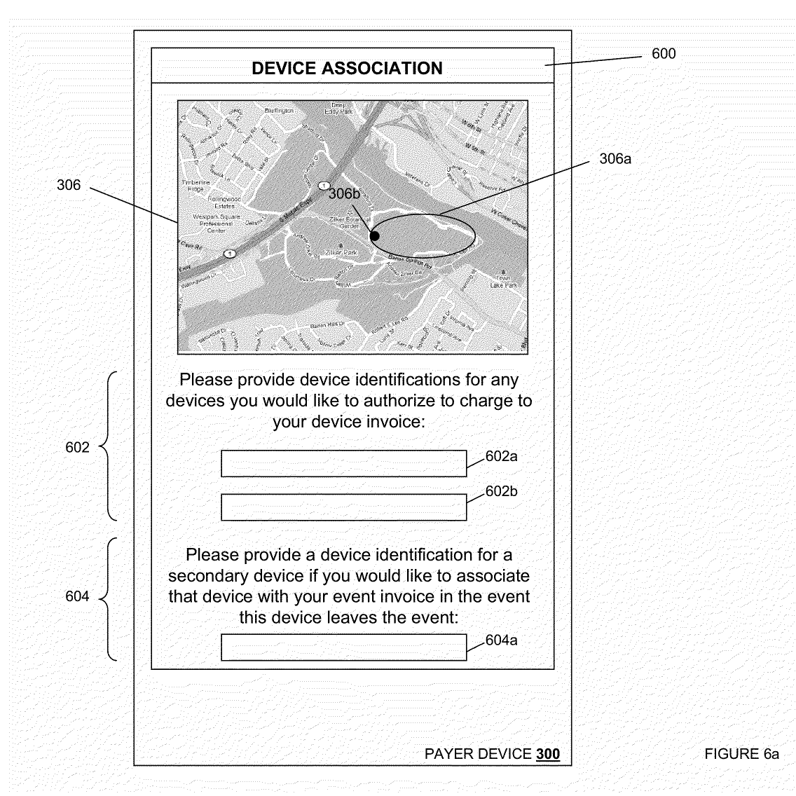

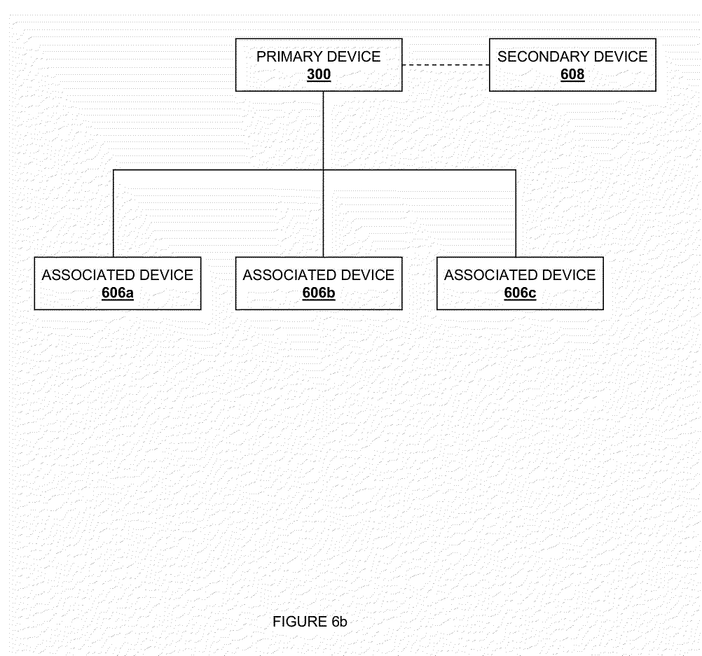

Referring now to FIGS. 6a and 6b, the location based charging system 200 and/or 500 may allow the payer device 300 to associate other devices with the event invoice. For example, at block 104 of the method 100, the location based payer charging system 200 may provide the payer device 300 with a device association screen 600 that includes a device association section 602 and a secondary device designation section 604, as illustrated in FIG. 6a. The device association section 602 includes instructions to provide device identifications for devices to associate with the event invoice, along with a plurality of associated device input boxes 602a and 602b. The secondary device designation section 604 includes instructions to provide a device identification for a secondary device to associate with the event invoice in the event the payer device 300 leaves the event area, along with a secondary device input box 604a. As illustrated in FIG. 6b, the user of the payer device 300 may associate a plurality of associated device 606a, 606b, and 606c with the event invoice by providing device identifications for each of the associated device 606a, 606b, and 606c in the associated device input boxes 602a and 602b. The user of the payer device 300 may also associate a secondary device 606 with the event invoice by providing a device identification in the secondary device input box 604a. In an embodiment, device identifications for the associated devices and secondary device may include phone numbers for the devices, email addresses associated with the devices, usernames associated with the devices (and, for example, an application on each of the devices used to detect and/or track that device in the event area), and/or a variety of other device identifications known in the art.

One of skill in the art will recognize that the association of associated devices and a secondary device with the event invoice provides a variety of benefits. For example, a family may include a parent with the payer device 300, another parent with the secondary device 608, and children with the associated devices 606a, 606b, and 606c. Once each of the devices has been associated with the event invoice, the parents and children may split up within the event area, leave the event area at different times, enter different pay areas, etc. In one example, the parent with the primary device 300 may take one of the children with the associated device 606a to a particular pay area in the event area, while the parent with the secondary device 608 may go to a location in the event area alone, and the two children with the associated devices 606b and 606c may go to particular pay areas in the event area. All payer charging events detected by the payer device 300, the secondary device 608, and the associated devices 606a, 606b, and 606c will result in charges added to the single event invoice that is associated with the payer device 300. Furthermore, in the event the primary device 300 leaves the event area, the event invoice will then be associated with the secondary device 608 such that, for example, the associated device 606a, 606b, and 606c may still add charges to the event invoice after the payer device 300 has left the event area.

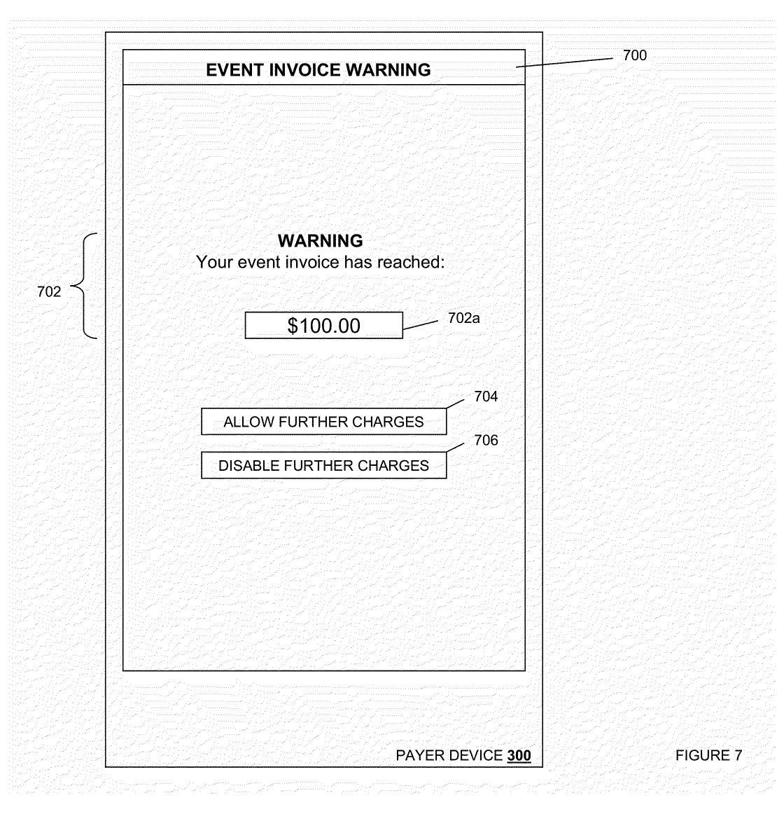

Referring now to FIG. 7, while in the event area, the location based payer charging system 200 may send the payer device 300 an event invoice warning 700 that includes a spending warning section 702 having an current event invoice amount 702a, along with an allow further charges button 704 and a disable further charges button 706. In an embodiment, the user of the payer device 300 may set a spending limit that is associated with the event invoice, and the location based payer charging system 200 will send the event invoice warning 700 in response to detecting that spending limit being reached. In response to receiving the event invoice warning 700, the user of the payer device 300 may select the allow further charges button 704 to allow further charges to be added to the event invoice, or select the disable further charges button 706 to prevent further charges from being added to the event invoice. If the event invoice is being charged based on an amount of time the payer device 300 is located in the event area, the payer device 300 may be sent a message to leave the event area in order to prevent further charges to the event invoice. In an embodiment, the location based notification 700 provides benefits when the event invoice is associated with associated devices and/or a secondary device (as discussed above with reference to FIGS. 6a and 6b), as charges added to the event invoice by the associated devices and/or a secondary device may be monitored or capped by the user of the payer device 300. In an embodiment, the event invoice warning 700 may include a listing of the different charges including the details of each charge (e.g., the name and/or cost of a pay area entered.)

Thus, a location based payer charging system has been described that allows a payer device to be charged based on the location of the payer device within an event area and/or pay areas within the event area. Through the association of the an event invoice with the payer device, associated devices, and/or secondary devices, charges may be added to the event invoice as the devices enter and leave the event area or pay areas within the event area, providing a simple and easy method for charging one or more persons in the event area.

The location based payer charging systems discussed above provide substantial benefits to charging payers for a variety of events. For example, the location based payer charging system including the plurality of pay areas within the event area provide for charging a payer for specific areas of the event, which may be useful for rides or shows at a fair, carnival, or amusement park, acts or shows at a music festival, and/or monuments or sights (e.g., a waterfall) at a national park. The time-based pricing scheme discussed above with reference to the location based payer charging system 200 may be useful for charging payers for time spent at a fair, carnival, amusement park, music festival, a national park, or sporting event. While a number of events have been provided as examples, one of skill in the art will recognize that a variety of other events will see substantial benefits to incorporating the location based payer charging system. Furthermore, the location based payer charging system may provide additional benefit due to its knowledge of the payer device location and its communicative connection to the payer device. For example, the location based payer charging system may detect that the payer device is located in a particular area of the event area and, in response, provide the payer device with information (e.g., text, images, web links, etc.) about that area (e.g., information about a monument in a sightseeing area may be provided to the payer device when the payer device is located at or near that monument.)

The present disclosure also provides a system and method for charging a payer for using a transportation system such as, for example, a train transportation system, a subway transportation system, a car/taxi transportation system, a bus transportation system, a toll road transportation system, and/or a variety of other transportation systems known in the art, based on the location of their payer device. As discussed above, the payer includes a payer device that is associated with a payer account. The payer account may be provided by a payee/transportation provider that is providing the transportation system, an account provider (e.g., a credit account provider, a checking account provider, a savings account provider, and/or a variety of other account providers known in the art), and/or a payment service provider that provides payment services for the transportation system (e.g., PayPal Inc. of

San Jose, CA) by, for example, providing a payer account for the payer, a payee account for the payee, and/or transferring payments from a payer account (e.g., provided by the account provider) to a payee account (e.g., provided by the account provider). A payer charging system receives location data from payer devices entering or attempting to enter and then leaving or attempting to leave the transportation system. Upon receiving the location data from the payer device exiting the transportation system, a payer account associated with the payer device is charged based on the location data received and a transportation charging element retrieved from a database.

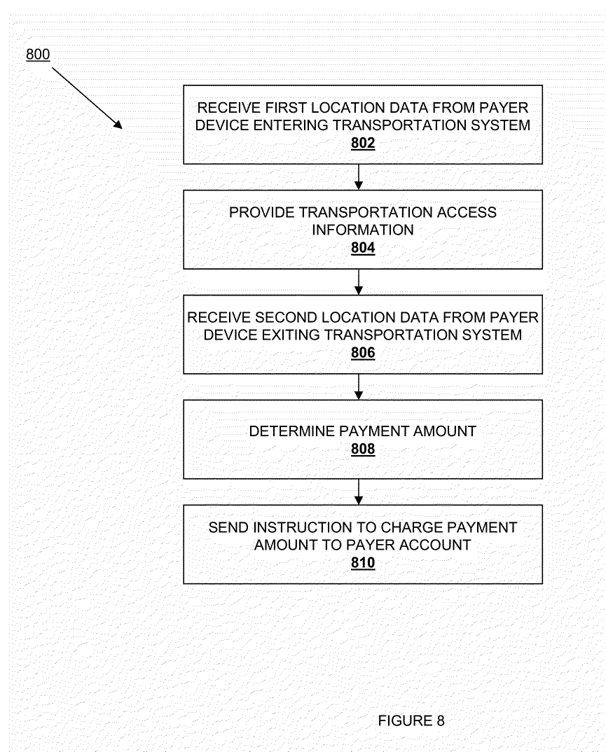

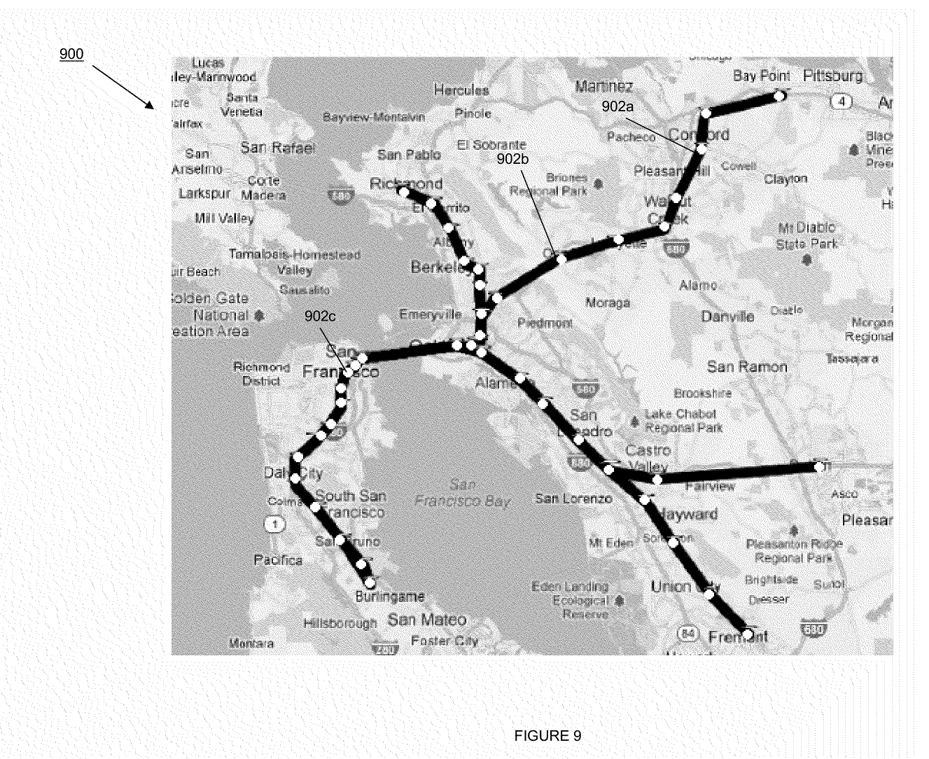

Referring now to FIGS. 8, 9, and 10a, a method 800 for charging a payer is illustrated. The method 800 begins at block 802 where first location data is received from a payer device entering or attempting to enter a transportation system area. FIG. 9 illustrates a transportation system 900 that includes a plurality of transportation areas (e.g., transportation areas 902a, 902b, and 902c.) In the embodiment illustrated and described below, the transportation system 900 is a train/subway transportation system that transports payers (as illustrated by the thick black lines in FIG. 9 that represent train/subway lines) between the plurality of transportation areas (as illustrated by the circled areas in FIG. 9 that represent train/subway stations) that are each located in a different geographic location (as illustrated by the underlying map in FIG. 9.) However, one of skill in the art will recognize that a variety of different transportation systems will fall within the scope of the present disclosure.

For example, the illustrated embodiment may also apply to a bus transportation system that transports payers (as illustrated by the thick black lines in FIG. 9 that represent bus routes) between the plurality of transportation areas (as illustrated by the circled areas in FIG. 9 that represent bus stops) that are each located in a different geographic location (as illustrated by the underlying map in FIG. 9.) In another example, the illustrated embodiment may also apply to a toll road transportation system that allows payers to travel (as illustrated by the thick black lines in FIG. 9 that represent toll roads) between the plurality of transportation areas (as illustrated by the circled areas in FIG. 9 that represent toll booth exits and entrances) that are each located in a different geographic location (as illustrated by the underlying map in FIG. 9.) In yet another embodiment, the transportation system may differ from that illustrated in FIG. 9, such as when the transportation system is a taxi transportation system that transports payers between different geographic locations that are not predetermined.

In an embodiment, the payer charging system includes a charging database that stores at least one transportation charge element that is associated with a transportation provider. As discussed in further detail below, transportation charge elements are used to determine payments amounts based on the different locations the payer enters and exits the transportation system, and may include a charge rate that is based on a distance traveled, a charge rate that is based on an entry and exit points, and/or a variety of other transportation charge elements known in the art.

In one example, the transportation provider provides the payer charging system and includes a transportation provider device having a database that includes the one or more transportation charge elements. In another example, the payment charging system may be separate from the transportation providers and includes a payment charging system provider device having a database that includes one or more transportation providers and at least one transportation charge elements associated with each of the one or more transportation providers. Thus, the payment service provider device, the account provider device, and/or other third party devices may include a database that includes one or more transportation providers and at least one transportation charge elements associated with each of the one or more transportation providers.

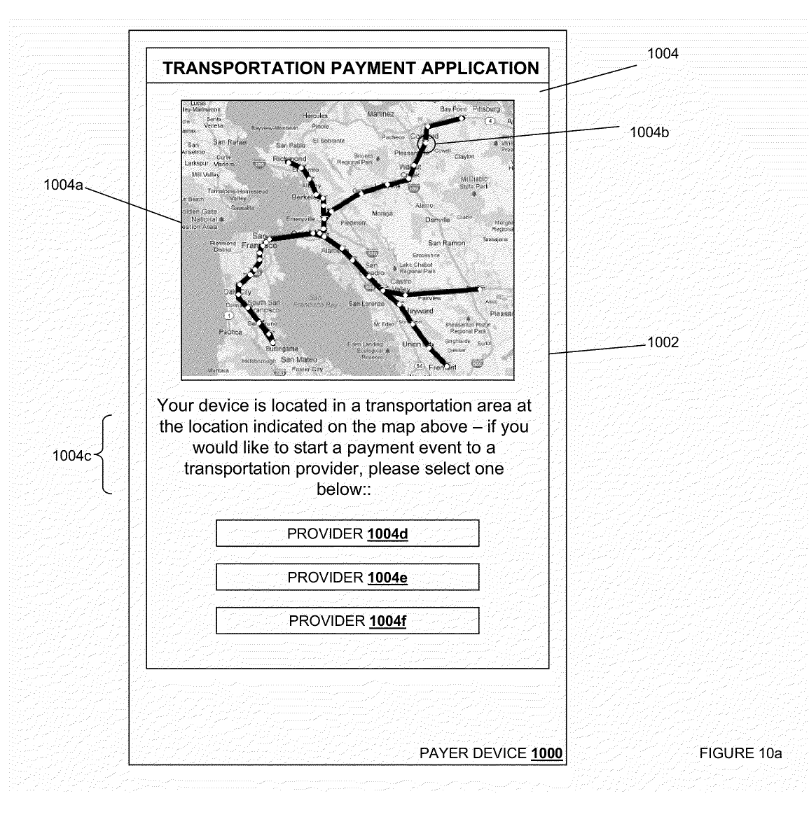

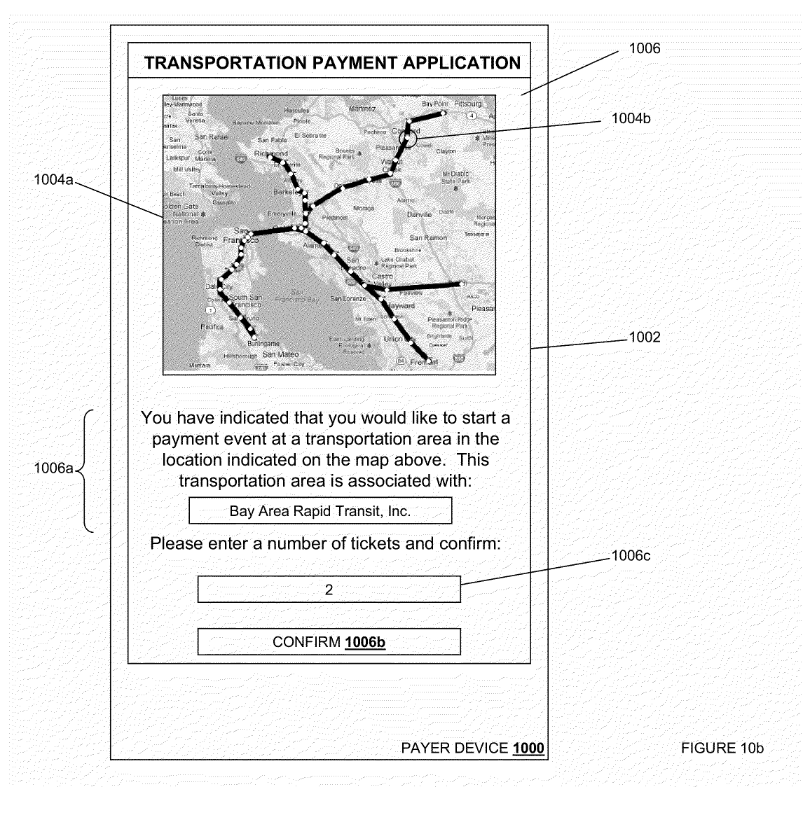

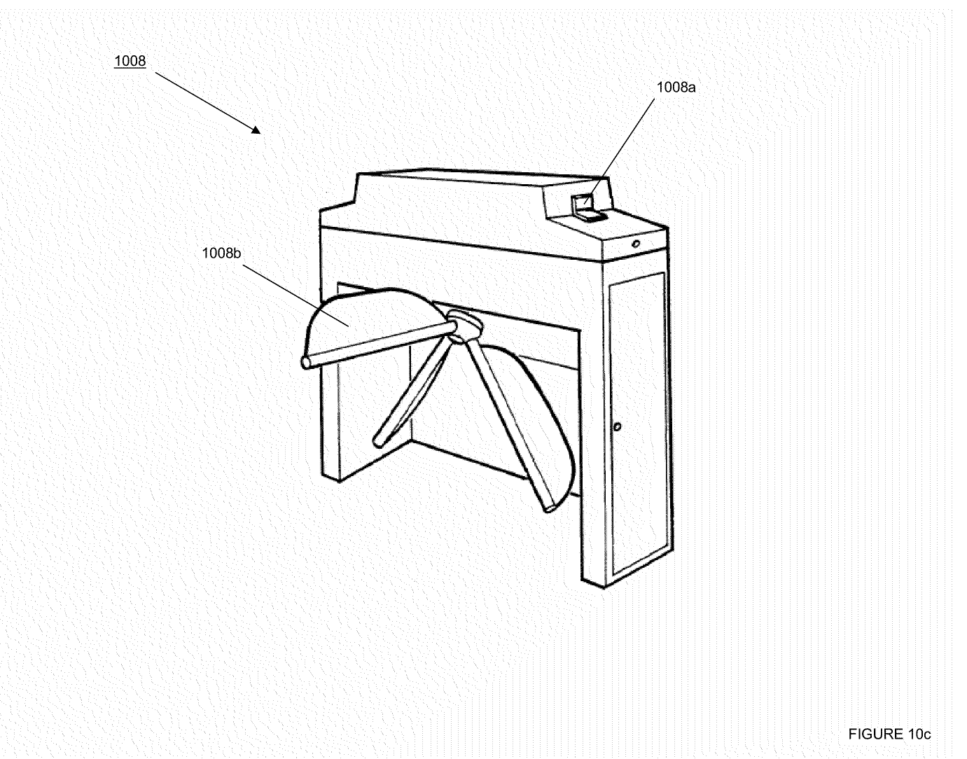

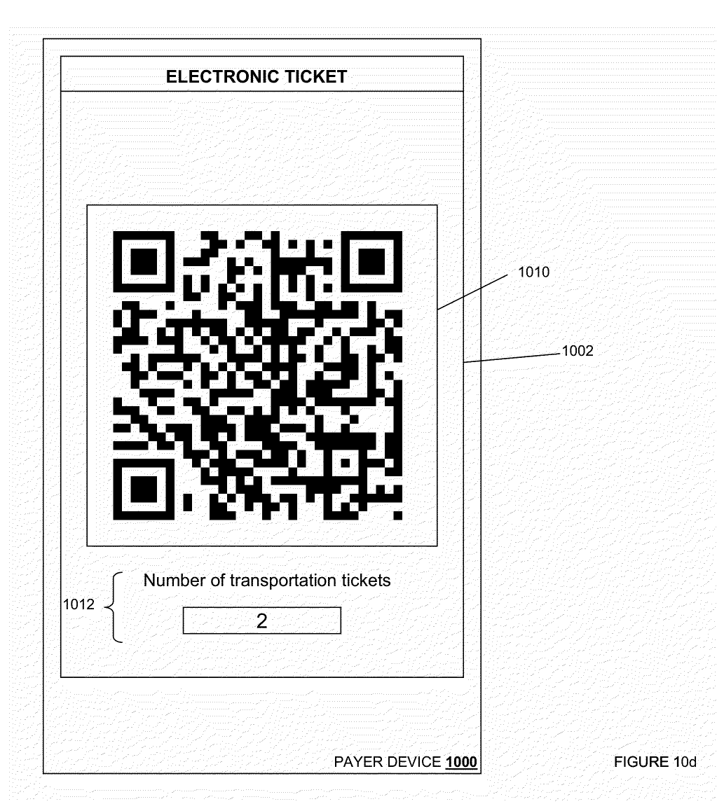

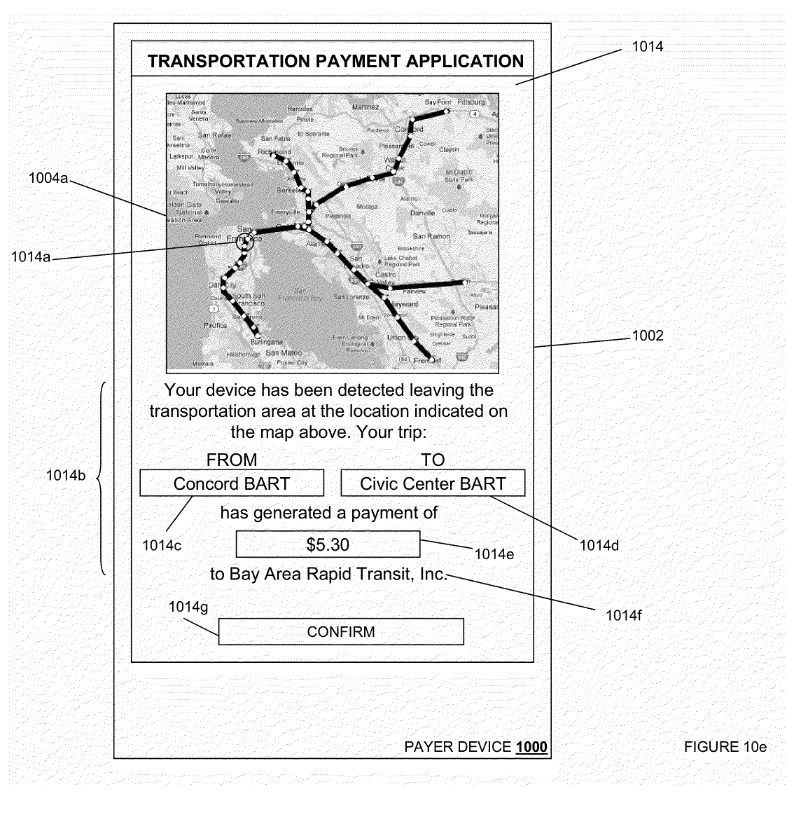

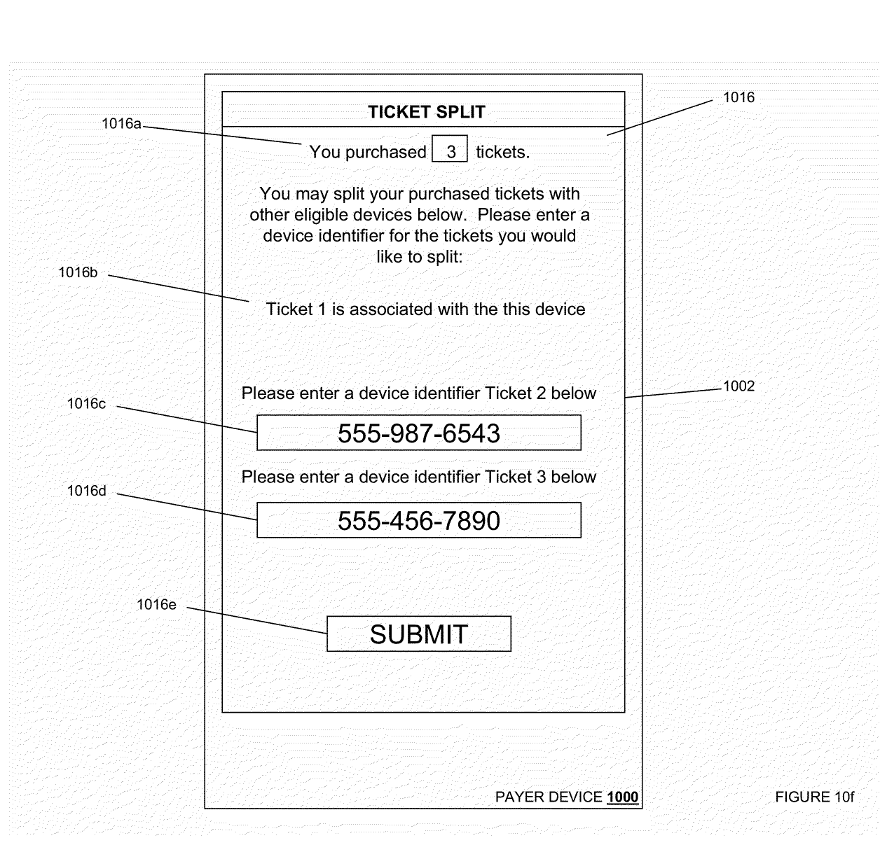

FIG. 10a illustrates an embodiment of a payer device 1000 including a display 1002. At block 802 of the method 800, a payer having the payer device 100 may enter a transportation area (e.g., the transportation area 902a illustrated in FIG. 9) in a transportation system (e.g., the transportation system 900 illustrated in FIG. 9). In some embodiments, transportation areas may be substantially similar to or include similar features of the event areas discussed above, and may detect payer devices entering and leaving the transportation area in manners similar to those described above. Thus, the transportation areas (e.g., train or subway stations, toll booths, etc.) and/or the transportation means (e.g., cars, taxis, busses, etc.) may include payer device detection systems similar to those discussed above with respect to the event areas. As discussed below, the sending of first location data from the payer device 1000 to the payer charging system provider device over a network upon entering or attempting to enter the transportation area may be accomplished in a variety of different manners that result in the payer device 1000 retrieving the first location data using a location determination device that determines the location of the payer device 1000 using a Global Positioning System (GPS) device, a Wifi device, and/or a variety of other location determination technologies known in the art.

For example, the transportation area may broadcast a signal that is detectable by the payer device 1000 when the payer device is entering or attempting to enter the transportation area and, in response to detecting that signal, the payer device 1000 may automatically use a location determination device to determine the current location of the payer device 1000 and send that current location to the payer charging system provider device over the network. In this example, the payer device 1000 may include an application that is operable to detect the signal, cause the location determination to be performed, and send the current location.

In another example, the payer device 1000 may include a database of transportation systems and/or transportation areas, and the payer device 1000 may periodically determine its current location, check that current location against the database, and if the current location matches a transportation area in the database, automatically send the current location to the payer charging system provider device over the network. In this example, the payer device 1000 may include an application that is operable to periodically determine the current location of the payer device, check the current location against the database, and send the current location.

In yet another example, the payer may operate the payer device 1000 to retrieve and send the current location of the payer device 1000 to the payer charging system provider device over the network (e.g., when the payer wishes to use the transportation system and has entered or is attempting to enter the transportation area.) In this example, the payer device 1000 may include an application that the payer may use to instruct the payer device 1000 to retrieve and send the current location.

In the embodiment illustrated in FIG. 10a, the payer has entered or is attempting to enter the transportation area 902a, illustrated in FIG. 9, and the payer device 1000 is displaying a provider selection page 1004 on a transportation payment application. The provider selection page 1004 includes a graphical display of a transportation system map 1004a having a transportation area indication 1004b that indicates to the payer that the current location of the payer device 1000 is in a transportation area (e.g., the transportation area 902a.) The provider selection page 1004 also includes a transportation area detection section 1004c informing the payer that the payer device is located in a transportation area, along with a plurality of transportation providers 1004d, 1004e, and 1004f that are associated with that transportation area.

In some embodiments, the payer may have used the payer device 1000 to launch the transportation payment application that is stored on the payer device 1000. In one example, the transportation payment application may use a location determination device to determine the current location of the payer device 1000, and access a database in the payer device 1000 to determine that the current location of the payer device 1000 is associated with a transportation area and that the transportation providers 1004d, 1004e, and 1004f are associated with that transportation area. In another example, the transportation payment application may use a location determination device to determine the current location of the payer device 1000, send that current location over the network to the payer charging system provider device, and receive back the transportation area and the transportation providers 1004d, 1004e, and 1004f that are associated with that transportation area.

In some embodiments, the current location of the payer device 1000 may be sent by the payer device 1000 over the network to the payer charging system provider device upon entering or attempting to enter the transportation area 902a, as discussed above. In response, the payer charging system provider device may provide the provider selection page 1004 to the payer device 1000 over the network. Thus, in some embodiments, the provider selection page 1004 may be a web page located on a website operated by the payer charging system provider device.

The payer may use the payer device 1000 to select one of the transportation providers 1004d, 1004e, and 1004f on the provider selection page 1004, and that information will be sent over the network to the payer charging system provider device. The payer charging system provider device will then provide, over the network to the payer device 1000, a provider confirmation page 1006 including the transportation system map 1004a having a transportation area indication 1004b, along with a provider information section 1006a indicating the provider the payer has selected and a confirm button 1006b, as illustrated in FIG. 10b. In some embodiments, a ticket number input 1006c is provided to allow the payer to indicate a number of tickets to charge to the payer device for the use of the transportation system. The payer may use the payer device 1000 to select the confirm button 1006a (and in some embodiments, provide a number of tickets in the ticket number input 1006c) in order to confirm that the payer would like to start a payment event at the transportation area 902a. In some embodiments, the sending of a confirmation from the payer device 1000 to the payer charging system provider device results in the payer charging system provider device associating the payer device 1000 with a transportation invoice that is similar to the event invoice described above.

In one embodiment, the first location data may be sent from the payer device 1000 to the payer charging system provider device upon the payer selecting the confirm button 1006a. For example, in the embodiment discussed above including the transportation payment application that determines the current location of the payer device 1000 and retrieves the associated transportation area and transportation providers from a database in the payer device 1000, the first location data may be first sent from the payer device to the payer charging system provider upon the payer selection of the confirm button 1006b.

However, in other embodiment, the first location data may have already been sent from the payer device 1000 to the payer charging system provider device (e.g., to retrieve the transportation area and transportation providers from a database in the payer charging system provider device), and thus the payer selection of the confirm button 1006b may simply provide a confirmation to the payer charging system provider device that the payer agrees to begin the payment event with the transportation provider and, in some embodiments, cause the payer device 1000 to be associated with the transportation invoice.

The embodiment illustrated in FIG. 10a includes the payer selecting from a plurality of transportation providers associated with the transportation area 902a. Such an embodiment is useful at transportation hubs that may include a number of different types of transportation providers (e.g., subway transportation providers, bus transportation providers, car/taxi transportation providers, etc.) However, in many situation, there may only be one transportation provider at the current location of the payer device 1000. In such an embodiment, a provider selection page 1004 may not be provided to the payer device 1000, and rather a page similar to the provider confirmation page 1006 may be provided that includes the only transportation provider associated with the current location of the payer device 1000.

Furthermore, as discussed above, in some embodiments the payer may not need to use the payer device 1000 to confirm a transportation provider upon entering or attempting to enter the transportation area. For example, the payer may set up the payer device (e.g., through the transportation payment application) to automatically confirm a transportation provider upon the determination being made that the current location of the payer device 1000 is associated with a transportation area that is associated with that transportation provider. Thus, rather than providing the provider selection page 1004 and the provider confirmation page 1006 on the payer device 1000 as illustrated in FIGS. 10a and 10b, the current location of the payer device 1000 may be sent to the payer charging system provider device over the network as discussed above in response to the payer entering or attempting to enter the transportation area, and a transportation invoice may be associated with the payer device 1000 such that a payment event begins. In such an automatic confirmation embodiment, the payer device may operate to periodically check the location of the payer device 1000 to determine if the location of the payer device 1000 coincides with the known locations of the transportation system (e.g., the train or subway route, the bus route, the toll road, etc.) This allows the payer device to determine whether the payer is actually using the transportation system, and to cancel the payment event if the automatic confirmation was made in error that the payer is not actually using the transportation system (i.e., the payer device 1000 is detected as being outside the location of the transportation system.)

Referring now to FIGS. 8, 10c, and 10d, the method 100 then proceeds to block 804, where transportation access information that is associated with the transportation provider may be sent to the payer device and/or the transportation provider device. For example, the transportation provider may require that the payer present a ticket or other indication of payment in order to enter the transportation area or before transportation begins.

FIG. 10c illustrates an embodiment of a transportation area access device 1008 that may be included in the transportation area 902a. The transportation area access device 1008 may include a base having a ticket checking mechanism 1008a and an access member 1008b. As is known in the art, the transportation area access device 1008 may restrict movement of the access member 1008b unless a valid ticket is presented to the ticket checking mechanism 1008a.

At block 804, following automatic or user provided confirmation of the transportation provider at block 802 of the method 800, the payer charging system provider device may provide an electronic ticket 1010 to the payer device 1000 over the network. The electronic ticket includes a machine-readable code (e.g., a Quick Response (QR) code in the illustrated embodiment, a Universal Product Code (UPC), and/or a variety of other machine-readable codes known in the art) that is associated with the transportation provider and that includes any information needed to allow the payer to enter the transportation system 900 through the transportation area. In some embodiments, the electronic ticket 1010 may include human-readable information 1012 about the electronic ticket 1010. In an embodiment, the payer charging system provider device provides the information in the electronic ticket over the network to the transportation provider device, and the transportation provider device stores that information in a database.

Thus, at block 804, the payer may present the electronic ticket 1010 on the payer device 1000 to the ticket checking mechanism 1008a such that the transportation area access device 1008 allows movement of the access member 1008b such that the payer may enter the transportation system 900 from the transportation area 902a. For example, the transportation provider may retrieve the information from the machine-readable code on the electronic ticket 1010 and compare it to information sent from the payer charging system provider device to confirm that the electronic ticket is valid, and then allow the payer to enter the transportation system 900 at the transportation area 902a. In other embodiments, the payer may present the electronic ticket on the payer device 1000 to an electronic ticket reader in a car/taxi, a bus, at a toll booth, or in a variety of other transportation scenarios to access the transportation system or have the transportation provider begin transportation (e.g., a car/taxi may require confirmation that the payment event has started prior to begin transportation.)

In some embodiments, the transportation access information may be provided to the payer device 1000 and then broadcast by the payer device 1000 to allow the payer to access or enter the transportation area. For example, the payer device 1000 may include a Near Field Communication (NFC) device or other broadcasting communication device that is operable to broadcast the transportation access information in the transportation area to gain access to the transportation system (e.g., the transportation area access device 1008 may allow movement of the access member 1008b upon receiving the broadcasted transportation access information from the payer device 1000 such that the payer may enter the transportation system 900 at the transportation area 902a.)

The method 800 then proceeds to block 806 where second location data is received from the payer device when the payer exits the transportation system. Upon arriving at their desired destination, the payer will exit the transportation system at a transportation area. For example, in the transportation system 900 illustrated in FIG. 9, the payer that entered the transportation system 900 at the transportation area 902a may exit the transportation system at the transportation area 902c. As discussed below, the sending of second location data from the payer device 1000 to the payer charging system provider device over a network upon exiting or attempting to exist the transportation area may occur in a variety of different ways. As discussed above, in some embodiments, the system may detect payer devices leaving the transportation area in similar manners used for detecting payer devices leaving the events areas discussed above.

For example, the transportation system may broadcast a signal that is detectable by the payer device 1000 when the payer device is located in the transportation system. When the payer exits the transportation system such that the payer device 1000 no longer detects the signal, the payer device 1000 may determine its current location and send it over the network to the payer charging system provider device. In this example, the payer device 1000 may include an application that is operable to detect the loss of the signal, cause the location determination to be performed, and send the current location.

In another example, the payer device 1000 may include a database of transportation systems and/or transportation areas, and the payer device 1000 may periodically determine its current location, check that current location against the database, and if the current location is no longer in the transportation system or a transportation area that is in the database, automatically send the current location of the payer device 1000 to the payer charging system provider device over the network. In this example, the payer device 1000 may include an application that is operable to periodically determine the current location of the payer device, check the current location against the database, and send the current location.

In yet another example, the payer may operate the payer device 1000 to retrieve and send the current location of the payer device 1000 to the payer charging system provider device over the network (e.g., when the payer wishes to exit the transportation system and exiting or is attempting to exit the transportation area.) In this example, the payer device 1000 may include an application that the payer may use to instruct the payer device 1000 to retrieve and send its current location.

In yet another example, the payer may use the transportation access information to exit the transportation system. For example, the payer may present the electronic ticket 1010 on the payer device 1000 to a ticket checking mechanism 1008a such that the transportation area access device 1008 allows movement of the access member 1008b such that the payer may exit the transportation system 900 from the transportation area 902c similarly as described above for entering the transportation system 900 from the transportation area 902a. In another example, the transportation access information may be broadcast by the payer device 1000 in the transportation area to exit to the transportation system (e.g., the transportation area access device 1008 may allow movement of the access member 1008b upon receiving the broadcast transportation access information such that the payer may exit the transportation system 900 at the transportation area 902c.) Exiting the transportation system using the transportation access information may cause the transportation provider device to indicate to the payer charging system provider device that the payer device has left the transportation system. In response, the payer charging system provider device may then retrieve the current location of the second payer device.

The method 1000 then proceeds to block 808 where a payment amount is determined. Upon receiving the second location data from the payer device 1000 over the network, the payer charging system provider device may retrieve from the database one or more transportation charge elements from the database. The payer charging system provider device then uses the first location data, the second location data, and the one or more transportation charge elements to determine the payment amount. Depending on the transportation system being used, the determination of the payment amount may be performed in a variety of ways.

For example, using a train/subway transportation system like the transportation system 900 illustrated in FIG. 9, the first location data for the transportation area 902a may correspond to a first train/subway stop, and the second location data for the transportation area 902c may correspond to a second train/subway stop. As is known in the art, set costs may be associated with travel between any two stops (i.e., transportation areas) in a train/subway transportation system. Thus, in this embodiment, the payer charging system provider device may use the first location data (i.e., the first train/subway stop) and the second location data (i.e., the second train/subway stop) to retrieve a transportation element from the database that provides the cost to travel between those two stops, thus determining the payment amount.

In a similar example, using a toll road transportation system, the first location data may correspond to a toll road entrance, and the second location data may correspond to a toll road exit. As is known in the art, set costs may be associated with travel between any entrance and exit (i.e., transportation areas) in a toll road transportation system. Thus, in this embodiment, the payer charging system provider device may use the first location data (i.e., the toll road entrance) and the second location data (i.e., the toll road exit) to retrieve a transportation element from the database that provides the cost to travel between that toll road entrance and exit, thus determining the payment amount.

In a another example, using a car/taxi transportation system, the first location data may correspond to a payer pick-up location, and the second location data may correspond to a payer drop-off location. As is known in the art, cost per distance rates may be associated with travel between any pick-up location and drop-off location (i.e., transportation areas) in a car/taxi transportation system. Thus, in this embodiment, the payer charging system provider device may to retrieve a transportation element from the database that provides the cost per distance rates for the car/taxi transportation provider, then use the first location data (i.e., the payer pick-up location) and the second location data (i.e., the payer drop-off location) to calculate the cost to travel from the payer pick-up location to the payer drop-off location, thus determining the payment amount.

In some embodiments, at block 808, the determination of the payment amount may include a determination of a refund amount in order to determine the payment amount. For example, the transportation provider may offer a transportation time guarantee that promises the payer a refund if the time it takes to travel between two locations exceeds a maximum time. In such an example, the payer charging system provider device determines a time it took for the payer to travel between the first location and the second location, retrieves a maximum travel time from a database, and compares the two to determine whether the time it took the payer to travel between the two locations exceeds the maximum travel time. In some embodiments, the payer device may track the travel time between the first location and the second location and then provide that travel time to the payer charging system provider device at block 806 of the method 800. In other embodiments, the transportation provider may track the travel time between the first location and the second location and then provide that travel time to the payer charging system provider device at block 806 of the method 800. In an embodiment, the refund amount may be any portion of the payment amount including, in some situations, the entire payment amount. Furthermore, the transportation time guarantee may provide for different refund amounts or percentages for increasing travel times exceeding the maximum travel time. Thus, at block 808, the payer charging system provider device may determine a payment amount substantially as discussed above, then determine a refund amount, and subtract the refund amount from the payment amount to determine the amount to charge the payer account in block 810, discussed below.

Referring now to FIGS. 1 and 10e, the method 800 then proceeds to block 810 where instructions are sent to charge the payment amount to a payer account. In some embodiments, following the determination of the payment amount in block 808 of the method 800, the payer charging system provider device provides, over the network to the payer device 1000, a payment confirmation page 1014 including the transportation system map 1004a having a transportation area indication 1014a that indicates to the payer that the current location of the payer device is in a transportation area 902c, along with a payment summary 1014b that includes a first transportation area 1014c, a second transportation area 1014d, a payment amount 1014e, and a transportation provider 1014f. In some embodiments, the payment confirmation page 1014 also includes a confirmation button 1014g that the payer may select in order to send a confirmation of the payment amount to the transportation provider detailed in the payment summary 1014b over the network to the payer charging system provider device. In those embodiments, upon receiving the confirmation, the payer charging system provider device may then send an instruction to charge the payment amount to a payer account associated with the payer device 1000.

In other embodiments, the upon receiving the second location data from the payer device 1000, the payer charging system provider device may send an instruction to charge the payment amount to a payer account associated with the payer device 1000 without the need to receive confirmation from the payer, and thus the payment confirmation page 1014 illustrated in FIG. 10e may not be provided on the payer device 1000, or it may be provided similar to the charge notification 304 discussed above, with the payment summary 1014b as a receipt and without the confirm button 1014g.

Referring now to FIG. 10f, in some embodiments the payer may use the payer device 1000 to purchase multiple tickets (e.g., using the ticket number input 1006c illustrated in FIG. 10b.) In one embodiment, the tickets purchased using the payer device 1000 may be split up amongst multiple payer devices. For example, the payer with the payer device 1000 may operate substantially as described above at block 802 of the method 800 to start a payment event that includes the purchase of multiple tickets to use the transportation system. Then payer may then use the payer device 1000 to split those tickets between multiple devices by retrieving (e.g., over a network from the payer charging system provide device, from an application on the payer device 100, etc.) a ticket split page 1016, as illustrated in FIG. 10f. The ticket split page includes a ticket indicator 1016a that indicates the number of tickets the payer has purchased. In the illustrated embodiment, the payer has purchased 3 tickets, and the ticket split page includes a ticket association indicator 1016b that indicates one of the purchased tickets is assigned to the payer device 1000, a first ticket assignment input 1016c that allows the payer to enter a device identifier to assign one of the purchased tickets, a second ticket assignment input 1016d that allows the payer to enter a device identifier to assign another of the purchased tickets, and a submit button 1016e that allows the payer to submit the ticket assignment provided in the first ticket assignment input 1016c and the second ticket assignment input 1016d.

In one example, the payer may use the payer device to purchase 3 tickets such that the payer and two other users may use the transportation system. In some embodiments of block 802 of the method 800, each of the purchased tickets may be associated with the first location data sent from the payer device 1000. In other embodiments of block 802 of the method 800, the first location data may be received from the payer device and each of the user devices that was assigned a ticket subsequent to the payer splitting the tickets. In some embodiments, the payer may split the multiple tickets between the payer and the two other users of the transportation system before entering the first transportation area by providing device identifiers for user devices belonging to the two other users of the transportation system in the first ticket assignment input 1016c and the second ticket assignment input 1016d (e.g., a mobile phone number for each of the user devices in the illustrated embodiment.) In other embodiments, the payer may split the multiple tickets between the payer and the two other users of the transportation system after entering the first transportation area and while on using the transportation system in substantially the same manner. The device identifiers for those user devices may then be sent over the network to the payer charging system provider device such that the user devices are stored in a database with first location data either received from the payer device 1000 or retrieved from each of the user devices. In some of those embodiments, each of the payer device 1000 and the user devices may be provided the transportation access information at block 804 of the method 800 in order to access the transportation system. With each of the payer device 1000 and the user devices associated with first location data and a ticket in a database, each of the payer device 1000 and the user devices may then send the second location data at block 806 of the method 800, and the payment account of the payer will be charged according to blocks 808 and 810 of the method 800 substantially as described above.

While one example is provided above with three tickets purchased with the payer device and two of those tickets assigned to different user devices, one of skill in the art will recognize that any number of tickets may be assigned to any number of devices without departing from the scope of the present disclosure. For example, the payer may assign one ticket to a user device and keep the two other tickets assigned to the payer device 1000 to allow the user with the user device to leave the transportation area at a different stop than the payer and the other user. In another example, the payer may assign two tickets to a single user device in order to allow the two users with a single user device to leave the transportation area at a different stop than the payer.

Thus, a system and method for charging a payer has been described that allows a payer with a payer device to be charged for using a transportation based on location data sent from the payer device from two different locations. The location based charging system simplifies the use of transportation systems by the payer by allowing the payer device to travel through the transportation system simply by using their payer device to send location data and having the system calculate the payment amount using that location data. A few examples of real-world uses of the location-based payer charging system and method are provided below using some of the specific features of the systems and methods discussed above. However, those examples are not meant to be limiting, and one of skill in the art will recognize that the different examples may have features that can be combined while remaining within the scope of the present disclosure, while other features not described in the examples below but discussed in detail above may be added while remaining within the scope of the present disclosure.

In one example, the systems and methods discussed above may be provided in a train or subway transportation system. A payer entering a first train or subway station may operate their payer device to launch a transportation payment application, which will detect that the payer is at first train or subway station and prompt the payer to confirm that they wish to use the train or subway transportation system. Upon confirmation, the payer device sends first location data to the payer charging system and the payer device is either provided with an electronic ticket that the payer may present at a ticketing device to enter the first train or subway station, or the payer device may begin broadcasting access information such that the payer is allowed through an access device to enter the first train or subway station. They payer may then use the train or subway to travel to their destination in the train or subway transportation system and exit the train or subway transportation system at a second train or subway station. The payer device will determine that the payer is exiting the second train or subway station and automatically send second location data to the payer charging system. The payer charging system then calculates the payment for the trip by determining the cost to travel from the first train or subway station to the second train or subway station, and automatically sends an instruction to make a payment from a payer account associated with the payer device to a payee account associated with the train or subway transportation provider.

In another example, the systems and methods discussed above may be provided on a toll road transportation system. Upon encountering a first toll area, a transportation payment application on the payer device will detect that the payer is at first toll area and send first location data to the payer charging system. The payer device will then begin broadcasting access information such that the payer is allowed through an access device to enter the toll road transportation system through the first toll area. They payer may then use the toll road transportation system to travel to their destination in the toll road transportation system and exit the toll road transportation system at a second toll area. The payer device will determine that the payer is exiting the toll road transportation system through the second toll area and automatically send second location data to the payer charging system. The payer charging system then calculates the payment for the trip by determining the cost to travel from the first toll area to the second toll area, and automatically sends an instruction to make a payment from a payer account associated with the payer device to a payee account associated with the toll road transportation provider.

In another example, the systems and method discussed above may be provided in a car or taxi transportation system. A payer catching a car or taxi at a pick-up location may operate their payer device to launch a transportation payment application, which will detect that the payer is entering the car or taxi and prompt the payer to confirm that they wish to use the car or taxi transportation system. Upon confirmation, the payer device sends first location data to the payer charging system and the payer device is either provided with an electronic ticket that the payer may present to the car or taxi driver before the ride starts, or the payer device may begin broadcasting access information to an access device in the car or taxi that provides the car or taxi driver a confirmation before the ride starts. They payer may then use the car or taxi transportation system to travel to their destination at a drop-off location where they exit the car or taxi. The payer device will determine that the payer is exiting the car or taxi at the drop off location and automatically send second location data to the payer charging system. The payer charging system then calculates the payment for the trip by determining the cost to travel from the pick up location to the drop off location, and automatically sends an instruction to make a payment from a payer account associated with the payer device to a payee account associated with the car or taxi transportation provider.

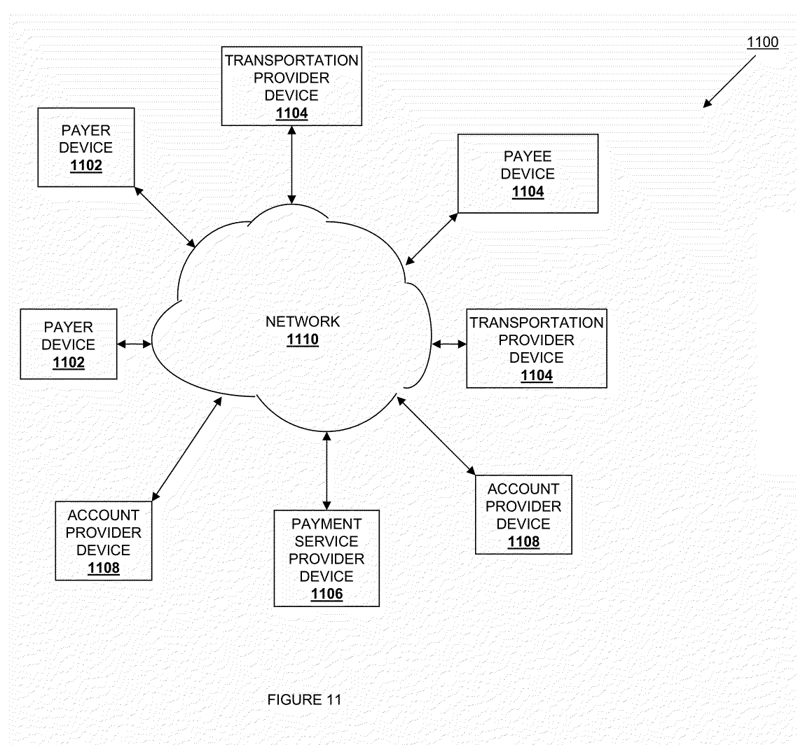

Referring now to FIG. 11, an embodiment of a networked system 1100 used in the location based payer charging system described above is illustrated. The networked system 1100 includes a plurality of payer devices 1102 (including associated payer devices and secondary payer devices), a plurality of payee or transportation provider devices 1104, a payment service provider device 1106, and a plurality of account holder devices 1108 in communication over a network 1110. Any of the payer devices 1102 may be the payer device 300 or 1000, discussed above. The payee or transportation provider devices 1104 may be a payee devices operated by the payee/event provider or the transportation providers discussed above. The payment service provider device 1106 may be operated by a payment service provider such as, for example, PayPal Inc. of San Jose, Calif. The account provider devices 1108 may be account provider devices operated by the account providers such as, for example, credit card account providers, bank account providers, savings account providers, and a variety of other account providers known in the art.

The payer devices 1102, payee or transportation provider devices 1104, payment service provider device 1106, and account provider devices 1108 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 1100, and/or accessible over the network 1110.

The network 1110 may be implemented as a single network or a combination of multiple networks. For example, in various embodiments, the network 1110 may include the Internet and/or one or more intranets, landline networks, wireless networks, and/or other appropriate types of networks.

The payer device 1102 may be implemented using any appropriate combination of hardware and/or software configured for wired and/or wireless communication over network 1110. For example, in one embodiment, the payer device 1102 may be implemented as a personal computer of a user in communication with the Internet. In other embodiments, the payer device 1102 may be a smart phone, personal digital assistant (PDA), laptop computer, and/or other types of computing devices.

The payer device 1102 may include one or more browser applications which may be used, for example, to provide a convenient interface to permit the payer to browse information available over the network 1110. For example, in one embodiment, the browser application may be implemented as a web browser configured to view information available over the Internet.

The payer device 1102 may also include one or more toolbar applications which may be used, for example, to provide user-side processing for performing desired tasks in response to operations selected by the payer. In one embodiment, the toolbar application may display a user interface in connection with the browser application.

The payer device 1102 may further include other applications as may be desired in particular embodiments to provide desired features to the payer device 1102. In particular, the other applications may include a payment application for payments assisted by a payment service provider through the payment service provider device 1106. The other applications may also include security applications for implementing user-side security features, programmatic user applications for interfacing with appropriate application programming interfaces (APIs) over the network 1110, or other types of applications. Email and/or text applications may also be included, which allow the payer to send and receive emails and/or text messages through the network 1110. The payer device 1102 includes one or more user and/or device identifiers which may be implemented, for example, as operating system registry entries, cookies associated with the browser application, identifiers associated with hardware of the payer device 1102, or other appropriate identifiers, such as a phone number.

In one embodiment, the user identifier may be used by the payment service provider device 1106 and/or account provider device 1108 to associate the user with a particular account as further described herein.

The payee or transportation provider devices 1104 may be maintained, for example, by the payee/event provider, the transportation providers, a conventional or on-line merchant, conventional or digital goods seller, individual seller, and/or application developer offering various products and/or services in exchange for payment to be received conventionally or over the network 1110. In this regard, the payee or transportation provider devices 1104 may include a database identifying available event areas, pay areas, transportation charge elements, products, and/or services (e.g., collectively referred to as items) which may be made available for viewing and purchase by the payer.

The payee or transportation provider devices 1104 also may include a checkout application which may be configured to facilitate the purchase by the payer of items or entry into event areas, transportation areas, or other pay areas. The checkout application may be configured to accept payment information from the user through the payer device 1102, the account provider through the account provider device 1108, and/or from the payment service provider through the payment service provider device 1106 over the network 1110.

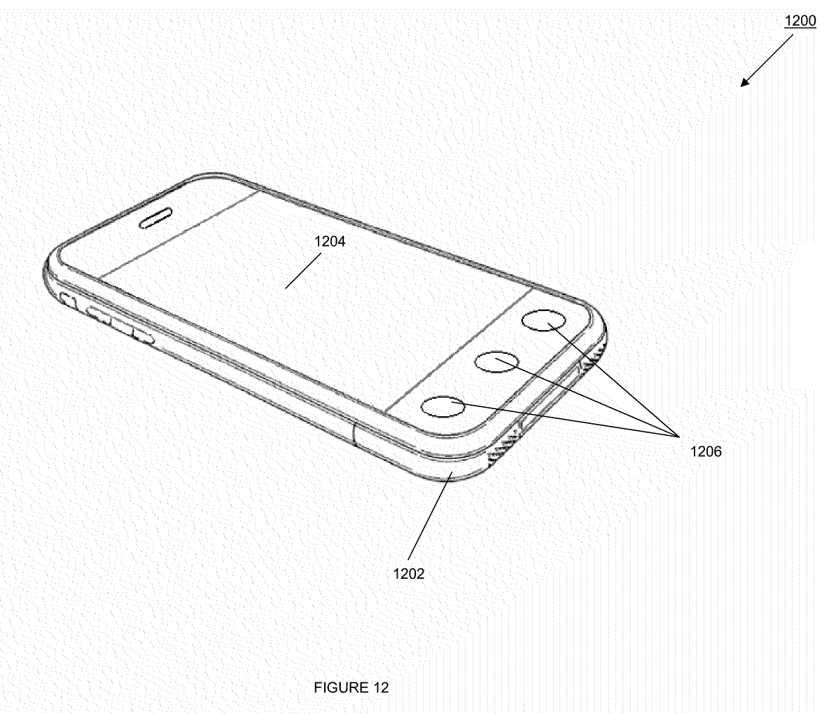

Referring now to FIG. 12, an embodiment of a payer device 1200 is illustrated. The payer device 1200 may be the payer devices 300, 1000, and/or 1102. The payer device 1200 includes a chassis 1202 having a display 1204 and an input device including the display 1204 and a plurality of input buttons 1206. One of skill in the art will recognize that the payer device 1200 is a portable or mobile phone including a touch screen input device and a plurality of input buttons that allow the functionality discussed above with reference to the method 100 or 800. However, a variety of other portable/mobile payer devices may be used in the method 100 or 800 without departing from the scope of the present disclosure.

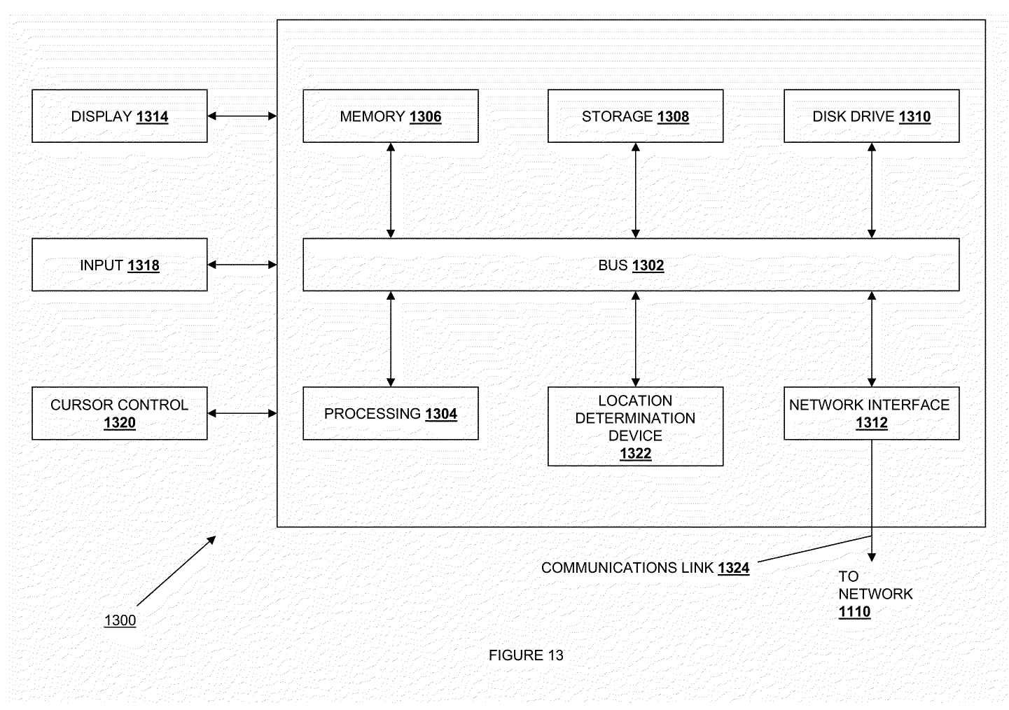

Referring now to FIG. 13, an embodiment of a computer system 1300 suitable for implementing, for example, the payer device 300, the payer device 1000, the payer device 1102, payee or transportation provider devices 1104, the payment service provider device 1106, and/or the account provider device 1108, is illustrated. It should be appreciated that other devices utilized by payer, payees, payment service providers, and account providers in the payment system discussed above may be implemented as the computer system 1300 in a manner as follows.

In accordance with various embodiments of the present disclosure, computer system 1300, such as a computer and/or a network server, includes a bus 1302 or other communication mechanism for communicating information, which interconnects subsystems and components, such as a processing component 1304 (e.g., processor, micro-controller, digital signal processor (DSP), etc.), a system memory component 1306 (e.g., RAM), a static storage component 1308 (e.g., ROM), a disk drive component 1310 (e.g., magnetic or optical), a network interface component 1312 (e.g., modem or Ethernet card), a display component 1314 (e.g., CRT or LCD), an input component 1318 (e.g., keyboard, keypad, or virtual keyboard), a cursor control component 1320 (e.g., mouse, pointer, or trackball), and/or a location determination component 1322 (e.g., a Global Positioning System (GPS) device as illustrated, a cell tower triangulation device, and/or a variety of other location determination devices known in the art.) In one implementation, the disk drive component 1310 may comprise a database having one or more disk drive components.

In accordance with embodiments of the present disclosure, the computer system 1300 performs specific operations by the processor 1304 executing one or more sequences of instructions contained in the memory component 1306, such as described herein with respect to the payer device 300, 1000, 1102, and 1200, the payee or transportation provider devices 1104, the payment service provider device 1106, and/or the account provider device(s) 1108. Such instructions may be read into the system memory component 1306 from another computer readable medium, such as the static storage component 1308 or the disk drive component 1310. In other embodiments, hard-wired circuitry may be used in place of or in combination with software instructions to implement the present disclosure.

Logic may be encoded in a computer readable medium, which may refer to any medium that participates in providing instructions to the processor 1304 for execution. Such a medium may take many forms, including but not limited to, non-volatile media, volatile media, and transmission media. In many embodiments, the computer readable medium is non-transitory. In various implementations, non-volatile media includes optical or magnetic disks, such as the disk drive component 1310, volatile media includes dynamic memory, such as the system memory component 1306, and transmission media includes coaxial cables, copper wire, and fiber optics, including wires that comprise the bus 1302. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by the computer system 1300. In various other embodiments of the present disclosure, a plurality of the computer systems 1300 coupled by a communication link 1324 to the network 1110 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1300 may transmit and receive messages, data, information and instructions, including one or more programs (i.e., application code) through the communication link 1324 and the network interface component 1312. The network interface component 1312 may include an antenna, either separate or integrated, to enable transmission and reception via the communication link 1324. Received program code may be executed by processor 1304 as received and/or stored in disk drive component 1310 or some other non-volatile storage component for execution.

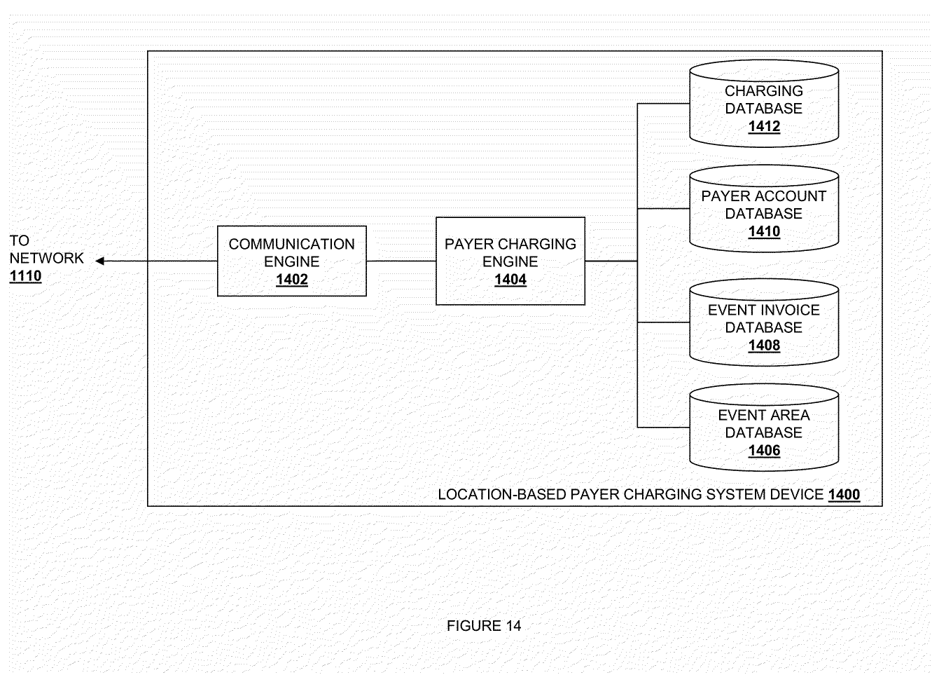

Referring now to FIGS. 14, an embodiment of a location based payer charging system device 1400 is illustrated. The device 1400 includes a communication engine 1402 that is coupled to the network 1110 and to an payer charging engine 1404 that is coupled to any or all of an event invoice database 1406, an event area database 1408, a payer account database 1410, and a charging database 1412. The communication engine 1402 may be software or instructions stored on a computer-readable medium that allows the device 1400 to send and receive information over the network 1110. In some embodiments, the payer charging engine 1404 may be software or instructions stored on a computer-readable medium that is operable to receive event area and pay area positioning coordinates and store them in the event area database 1408, receive and associate event invoices with payer devices and payers accounts in the event invoice database 1406, receive payer device locations, determine payer charging events, add charges to the event invoices, and provide any of the other functionality that is discussed above. In other embodiments, the payer charging engine 1404 may be software or instructions stored on a computer-readable medium that is operable to receive first location data and second location data from the payer device, determine a transportation provider associated with the first location data, retrieve transportation charge elements from the charge database, determine a payment amount using the first location data, the second location data, and the transportation charging element, send an instruction to make a payment using a payment account associated with the payer device in the payer account database 1410, and provide any of the other functionality that is discussed above.

While the databases 1406, 1408, 1410, and 1412 have been illustrated as located in the location-based payer charging system device 1400, one of skill in the art will recognize that they may be connected to the payer charging engine 1404 through the network 1110 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on payees and payers; however, a payer or consumer can pay, or otherwise interact with any type of recipient, including charities and individuals. The payment does not have to involve a purchase, but may be a loan, a charitable contribution, a gift, etc. Thus, payee as used herein can also include charities, individuals, and any other entity or person receiving a payment from a payer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A location-based payer charging system, comprising:
a system provider device including one or more processors that are coupled to a memory and a network, wherein the one or more processors are operable to:
receive first location data from a payer device over the network in response to the payer device entering a first transportation area;
receive second location data from the payer device over the network in response to the payer device exiting a second transportation area;
determine a payment amount using the first location data, the second location data, and a transportation charge element retrieved from a charging database; and
send an instruction to charge the payment amount to a payer account that is associated with the payer device.

2. The system of claim 1, wherein the system provider device is further operable to:
determine that the transportation provider is associated with the first location data.

3. The system of claim 1, wherein the system provider device is further operable to:
send a transportation ticket that is associated with the transportation provider over the network to the payer device.

4. The system of claim 3, wherein the system provider device is further operable to:
send the transportation ticket over the network to a transportation provider device of the transportation provider.

5. The system of claim 1, wherein the determining the payment amount includes calculating a distance traveled using the first location data and the second location data, and further calculating the payment amount using the distance traveled and the transportation charge element.

6. The system of claim 1, wherein the system provider device is further operable to:
determine that a plurality of transportation providers are associated with the first location data;
send the plurality of transportation providers to the payer device over the network; and
receive a selection of the transportation provider from the payer device over the network.

7. The system of claim 1, wherein the determining the payment amount and the sending the instruction to charge the payment amount to the payer account is performed automatically in response to receiving the second location data.

8. A method for charging a payer, comprising:
receiving first location data from a payer device over a network in response to the payer device entering a first transportation area;
receiving second location data from the payer device over the network in response to the payer device exiting a second transportation area;
determining a payment amount using the first location data, the second location data, and a transportation charge element retrieved from a charging database; and
sending an instruction to charge the payment amount to a payer account that is associated with the payer device.

9. The method of claim 8, further comprising:
determining that a transportation provider is associated with the first location data.

10. The method of claim 9, further comprising:
sending a transportation ticket that is associated with the transportation provider over the network to the payer device.

11. The method of claim 10, further comprising:
sending the transportation ticket over the network to a transportation provider device of the transportation provider.

12. The method of claim 8, wherein the determining the payment amount includes calculating a distance traveled using the first location data and the second location data, and further calculating the payment amount using the distance traveled and the transportation charge element.

13. The method of claim 8, further comprising:
determining that a plurality of transportation providers are associated with the first location data;
sending the plurality of transportation providers to the payer device over the network; and
receiving a selection of one of the plurality of transportation providers from the payer device over the network.

14. The method of claim 8, wherein the determining the payment amount and the sending the instruction to charge the payment amount to the payer account is performed automatically in response to receiving the second location data.

15. A non-transitory machine-readable medium comprising a plurality of machine-readable instructions which, when executed by one or more processors, are adapted to cause the one or more processors to perform a method comprising:
receiving first location data from a payer device over a network in response to the payer device entering a first transportation area;
determining that a transportation provider is associated with the first transportation area;
receiving second location data from the payer device over the network in response to the payer device exiting a second transportation area;
determining a payment amount using the first location data, the second location data, and a transportation charge element that is associated with the transportation provider and retrieved from a charging database; and
sending an instruction to charge the payment amount to a payer account that is associated with the payer device.

16. The non-transitory machine-readable medium of claim 15, wherein the method further comprises:
sending a transportation ticket that is associated with the transportation provider over the network to the payer device.

17. The non-transitory machine-readable medium of claim 16, wherein the method further comprises:
sending the transportation ticket over the network to a transportation provider device of the transportation provider.

18. The non-transitory machine-readable medium of claim 15, wherein the determining the payment amount includes calculating a distance traveled using the first location data and the second location data, and further calculating the payment amount using the distance traveled and the transportation charge element.

19. The non-transitory machine-readable medium of claim 15, wherein the method further comprises:
determining that a plurality of transportation providers are associated with the first location data; sending the plurality of transportation providers to the payer device over the network; and
receiving a selection of the transportation provider from the payer device over the network.

20. The non-transitory machine-readable medium of claim 15, wherein the determining the payment amount and the sending the instruction to charge the payment amount to the payer account is performed automatically in response to receiving the second location data.
